(19) United States
(12) Patent Application Publication
(10) Pub. No.: US 2024/0015550 A1
(43) Pub. Date: Jan. 11, 2024

(54) Linked Radio-Layer and Application-Layer Measurements in a Wireless Network

(71) Applicant: Telefonaktiebolaget LM Ericsson (publ), Stockholm (SE)

(72) Inventors: Ali Parichehrehteroujeni, Linköping (SE); Angelo Centonza, Torrenueva Costa, Granada (ES); Pradeepa Ramachandra, Linköping (SE); Johan Rune, Lidingö (SE); Luca Lunardi, Genoa (IT); Sakib Bin Redhwan, Linköping (SE); Filip Barac, Huddinge (SE); Cecilia Eklöf, Täby (SE)

(21) Appl. No.: 18/023,450

(22) PCT Filed: Sep. 15, 2021
(86) PCT No.: PCT/SE2021/050882

§ 371 Date: Feb. 27, 2023

Related U.S. Application Data
(60) Provisional application No. 63/089,588, filed on Oct. 9, 2020.

(51) Int. Cl. H04W 24/10; H04W 24/02; H04W 24/08

(52) U.S. Cl. CPC H04W 24/10; H04W 24/02; H04W 24/08

(57) ABSTRACT

Embodiments include methods for a user equipment (UE) to perform radio-layer and application-layer measurements in a radio access network (RAN). Such methods include receiving the following from a RAN node: a first configuration of radio-layer measurements to be performed by the UE, a second configuration of application-layer measurements to be performed by the UE, and an indication that the radio-layer measurements and the application-layer measurements should be linked. Such methods include performing application-layer measurements related to one or more applications based on the second configuration, and performing radio-layer measurements based on the first configuration. At least a portion of the radio-layer measurements are performed concurrently with at least a portion of the application-layer measurements. Other embodiments include complementary methods for RAN nodes and network nodes or functions outside the RAN. Other embodiments include corresponding apparatus configured to perform these methods.

### TECHNICAL FIELD

The present disclosure relates generally to wireless communication networks and more specifically to efficient techniques for performing, reporting, and analyzing various measurements by user equipment (UE) operating in a wireless network.

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

5G/NR technology shares many similarities with LTE. For example, NR uses CP-OFDM (Cyclic Prefix Orthogonal Frequency Division Multiplexing) in the downlink (DL, i.e., from the network) and both CP-OFDM and DFT-spread OFDM (DFT-S-OFDM) in the uplink (UL, i.e., to the network). As another example, in the time domain, NR DL and UL physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. In addition to providing coverage via cells as in LTE, NR networks also provide coverage via “beams.” In general, a DL “beam” is a coverage area of a network-transmitted reference signal (RS) that may be measured or monitored by a user equipment (UE, e.g., wireless communication device).

Quality of Experience (QoE) measurements have been specified for UEs operating in LTE networks and in earlier-generation UMTS networks. Measurements in both networks operate according to the same high-level principles. Their purpose is to measure the experience of end users when using certain applications over a network. For example, QoE measurements for streaming services and for MTSI (Mobility Telephony Service for IMS) are supported in LTE. QoE measurements will also be needed for UEs operating in NR networks.

A new study item for “Study on NR QoE management and optimizations for diverse services” has been approved for NR Rel-17. The purpose is to study solutions for QoE measurements in NR, not only for streaming services as in LTE but also for other services such as augmented or virtual reality (AR/VR), URLLC, etc. Based on requirements of the various services, the NR study will also include more adaptive QoE management schemes that enable intelligent network optimization to satisfy user experience for diverse services.

Radio Resource Control (RRC) signaling is used to configure application-layer measurements in UEs and to collect QoE measurement result files from the configured UEs. In particular, application-layer measurement configuration from a core network (e.g., EPC) or a network operations/administration/maintenance (OAM) function is encapsulated in a transparent container and sent to a UE's serving base station, which forwards it to a UE in an RRC message. Application-layer measurements made by the UE are encapsulated in a transparent container and sent to the serving base station in an RRC message. The serving base station then forwards the container to a Trace Collector Entity (TCE) or a Measurement Collection Entity (MCE) associated with the core network.

In addition, a UE can be configured to perform and report measurements to support minimization of drive tests (MDT), which is intended to reduce and/or minimize the requirements for manual testing of actual network performance (i.e., by driving around the geographic coverage of the network). The MDT feature was first studied in LTE Rel-9 (e.g., 3GPP TR 36.805 v9.0.0) and first standardized in Rel-10. MDT can address various network performance improvements such as coverage optimization, capacity optimization, mobility optimization, quality-of-service (QoS) verification, and parameterization for common channels (e.g., PDSCH).

In general, QoE measurements relate to application-layer performance while MDT measurements relate to radio-layer performance. Conventionally, each type of measurement is collected and/or reported independently and/or without coordination with the other type. For example, QoE measurements may be logged at different times than MDT measurements. This independence and/or lack of coordination can cause various problems, issues, and/or difficulties in analysis of such measurements by a receiving entity.

### SUMMARY

Embodiments of the present disclosure provide specific improvements to QoE measurements in a wireless network, such as by facilitating solutions to overcome exemplary problems summarized above and described in more detail below.

Some embodiments of the present disclosure include exemplary methods (e.g., procedures) to perform radio-layer and application-layer measurements in a radio access network (RAN). These exemplary methods can be performed by a user equipment (UE, e.g., wireless device, IoT device, modem, etc.) in communication with a radio access network (RAN) node (e.g., base station, eNB, gNB, ng-eNB, en-gNB, etc.).

These exemplary methods can include receiving the following from the RAN node:
a first configuration of radio-layer measurements to be performed by the UE,
a second configuration of application-layer measurements to be performed by the UE, and
an indication that the radio-layer measurements and the application-layer measurements should be linked.
   These exemplary methods can also include, based on the second configuration, performing application-layer measurements related to one or more applications. These exemplary methods can also include performing radio-layer measurements based on the first configuration, wherein at least a portion of the radio-layer measurements are performed concurrently with at least a portion of the application-layer measurements.

In some embodiments, the radio-layer measurements can be minimization of drive testing (MDT) or trace measurements, while the application-layer measurements can be quality-of-experience (QoE) measurements.

In some embodiments, performing the application-layer measurements can include a UE application layer receiving from a UE radio layer one of the following first control indications for the application-layer measurements: a first start indication, a first stop indication, a first suspend indication, and a first resume indication. Subsequently, the UE (e.g., the application layer) can perform a responsive operation to the received first control indication. As an example, the UE application layer can initiate the application-layer measurements in response to the first start indication.

In some of these embodiments, the first control indication can be received in association with an identification of at least one application, of the one or more applications, to which the first control indication applies. In such embodiments, the responsive operation can be performed only on the identified at least one application. In some of these embodiments, the first control indication can be received by the UE application layer in association with a data packet from the UE radio layer.

In some embodiments, performing the radio-layer measurements can include receiving from a UE application layer one of the following second control indications for the radio-layer measurements: a second start indication, a second stop indication, a second suspend indication, and a second resume indication. Subsequently, the UE (e.g., radio layer) can perform a responsive operation to the received second control indication. As an example, the UE radio layer can initiate the radio-layer measurements in response to the second start indication.

In some of these embodiments, the second suspend indication includes a suspend duration. In such embodiments, performing the radio-layer measurements can include resuming suspended radio-layer measurements after expiration of the received suspend duration.

In some of these embodiments, the second control indication can be received by the UE radio layer in association with a data packet from the UE application layer.

In various embodiments, the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.

In various embodiments, the first configuration and the second configuration can include various information that facilitates linked radio-layer and application-layer measurements, as described in more detail below.

In some embodiments, these exemplary methods can also include sending, to the RAN node, one or more of the following:
one or more measurement timing parameters included in the second configuration,
a first measurement report related to the performed radio-layer measurements,
a second measurement report related to the performed application-layer measurements,
an indication that the UE initiated the application-layer measurements,
a request to perform radio-layer measurements at the RAN node, and
an absolute or relative time at which the RAN node should perform radio-layer measurements.

Other embodiments include exemplary methods (e.g., procedures) to configure a UE to perform radio-layer and application-layer measurements in a RAN. These exemplary methods can be performed a RAN node (e.g., base station, eNB, gNB, ng-eNB, etc., or components thereof).

These exemplary methods can include receiving, from a network node or function outside the RAN, a second configuration of application-layer measurements to be performed by the UE in relation to one or more applications. These exemplary methods can also include sending the following to the UE:
a first configuration of radio-layer measurements to be performed by the UE,
the second configuration, and
an indication that the radio-layer and application-layer measurements by the UE should be linked.
   These exemplary methods can also include performing radio-layer measurements that are linked with application-layer measurements performed by the UE based on the second configuration.

In some embodiments, the radio-layer measurements by the UE can be MDT or trace measurements, while the application-layer measurements by the UE can be QoE measurements.

In various embodiments, the indication that the radio-layer and application-layer measurements by the UE should be linked can include any of the corresponding indications summarized above in relation to UE embodiments.

In various embodiments, the first configuration and the second configuration can include various information that facilitates linked radio-layer and application-layer measurements, as described in more detail below.

In some embodiments, these exemplary methods can also include receiving, from the UE, one or more of the following:
one or more measurement timing parameters included in the second configuration,
a first measurement report related to UE radio-layer measurements,
a second measurement report related to UE application-layer measurements,
an indication that the UE initiated the application-layer measurements,
a request to perform radio-layer measurements at the RAN node, and
an absolute or relative time at which the RAN node should perform radio-layer measurements.
   In such embodiments, performing the radio-layer measurements can be responsive to one of the following:
the second measurement report,
the indication that the UE initiated the application-layer measurements, or
the request to perform radio-layer measurements at the RAN node.

In some of these embodiments, these exemplary methods can also include sending the following to the network node or function outside the RAN:
the first measurement report,
the second measurement report,
a third measurement report related to the radio-layer measurements performed by the RAN node, and
an indication that at least one of the first and third measurement reports is linked to the second measurement report.

In some embodiments, these exemplary methods can also include determining a starting time and/or a duration for the UE application-layer measurements based on one or more of the following:
inspection of the second configuration received from the network node or function outside the RAN,
one or more measurement timing parameters included in the second configuration, as received from the UE,
inspection of application session initiation messages forwarded by the RAN node to or from the UE, and
inspection of application session data packets forwarded by the RAN node to or from the UE.
   In such embodiments, the radio-layer measurements can be performed based on the determined starting time and/or the determined duration for the UE application-layer measurements.

Other embodiments include exemplary methods (e.g., procedures) for a network node or function coupled to a RAN. For example, such methods can be performed by a network management system (NMS, e.g., OAM system or similar) or a core network node or function (e.g., AMF).

These exemplary methods can include sending, to a RAN node, a second configuration of application-layer measurements to be performed by a UE served by the RAN node. These exemplary methods can also include receiving the following from the RAN node:
a first measurement report related to radio-layer measurements performed by the UE,
a second measurement report related to the application-layer measurements performed by the UE in relation to one or more applications,
a third measurement report related to radio-layer measurements performed by the RAN node, and
an indication that at least one of the first and third measurement reports is linked to the second measurement report.

In some embodiments, the radio-layer measurements by the UE can be MDT or trace measurements, while the application-layer measurements by the UE can be QoE measurements.

In some embodiments, the second configuration includes one or more of the following:
a pause criterion for the UE application-layer measurements that is related to the UE radio-layer measurements,
a second absolute time,
a time offset relative to a first absolute time included in the first configuration, and
an indication that UE application-layer measurement reports should include associations between radio resources and particular applications.

Other embodiments include UEs (e.g., wireless devices, IoT devices, etc. or component(s) thereof), RAN nodes (e.g., base stations, eNBs, gNBs, ng-eNBs, en-gNBs, etc., or components thereof), and network nodes or functions coupled to a RAN (e.g., OAM, AMF, etc.) that are configured to perform operations corresponding to any of the exemplary methods described herein. Other embodiments include non-transitory, computer-readable media storing program instructions that, when executed by processing circuitry, configure such UEs, RAN nodes, or network nodes or functions coupled to a RAN to perform operations corresponding to any of the exemplary methods described herein.

These and other embodiments described herein can enable a network entity (e.g., management system) that analyzes measurements to couple and merge relevant radio-layer and application-layer measurements in an accurate way, leading to a better network optimization decisions. Embodiments can facilitate matching application-layer and radio-layer measurement samples logged roughly at the same time in two reports, while avoiding duplication of the radio-layer measurement logging at the application layer. This avoidance of duplication can improve operation of both the UE and the network. Other advantages include improved observability that provides network operators more extensive and accurate insights into end-user experience and greater control of network compliance with Service Level Agreements (SLAs). Improved observability also enables more informed decisions in areas such as network design and optimization, service optimization, service offerings, etc.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary architecture of an LTE network.

FIGS. 2-3 illustrate two high-level views of an exemplary 5G/NR network architecture.

FIG. 4 shows an exemplary configuration of NR user plane (UP) and control plane (CP) protocol stacks.

FIGS. 5A-D show various procedures between a UTRAN and a UE for QoE measurements in a legacy UMTS network.

FIGS. 6A-C illustrate various aspects of QoE measurement configuration for a UE in an LTE network.

FIGS. 7A-C illustrate various aspects of QoE measurement collection for a UE in an LTE network.

FIG. 8 illustrates exemplary application-layer (e.g., QoE) and radio-layer measurements by a UE and a RAN node, according to various embodiments of the present disclosure.

FIG. 9, which includes FIGS. 9A-B, shows an exemplary ASN.1 data structure for a MeasResult information element (IE), according to various embodiments of the present disclosure

FIG. 10 shows an exemplary ASN.1 data structure for a MeasReportAppLayer IE, according to various embodiments of the present disclosure.

FIG. 11 is a flow diagram of an exemplary method (e.g., procedure) for a UE (e.g., wireless device, IoT device, etc. or component(s) thereof), according to various embodiments of the present disclosure.

FIG. 12 is a flow diagram of an exemplary method (e.g., procedure) for a RAN node (e.g., eNB, gNB, ng-eNB, etc. or component(s) thereof), according to various embodiments of the present disclosure.

FIG. 13 is a flow diagram of an exemplary method (e.g., procedure) for a network node or function (e.g., OAM, AMF, etc.) coupled to a RAN, according to various embodiments of the present disclosure.

FIG. 14 is a block diagram of an exemplary wireless device or UE according to various embodiments of the present disclosure.

FIG. 15 is a block diagram of an exemplary network node according to various embodiments of the present disclosure.

FIG. 16 is a block diagram of an exemplary network configured to provide over-the-top (OTT) data services between a host computer and a UE, according to various embodiments of the present disclosure.

### DETAILED DESCRIPTION

Embodiments summarized above will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB/en-gNB) in a 3GPP Fifth Generation (5G) NR network or an enhanced or evolved Node B (eNB/ng-eNB) in a 3GPP LTE network), base station distributed components (e.g., CU and DU), base station control- and/or user-plane components (e.g., CU-CP, CU-UP), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, QoE and MDT measurements are collected and/or reported independently and/or without coordination with each other. For example, QoE measurements may be logged at different times than MDT measurements. This independence and/or lack of coordination can cause various problems, issues, and/or difficulties in analysis of such measurements by a receiving entity. This is discussed in more detail below, after the following description of LTE and NR network architectures.

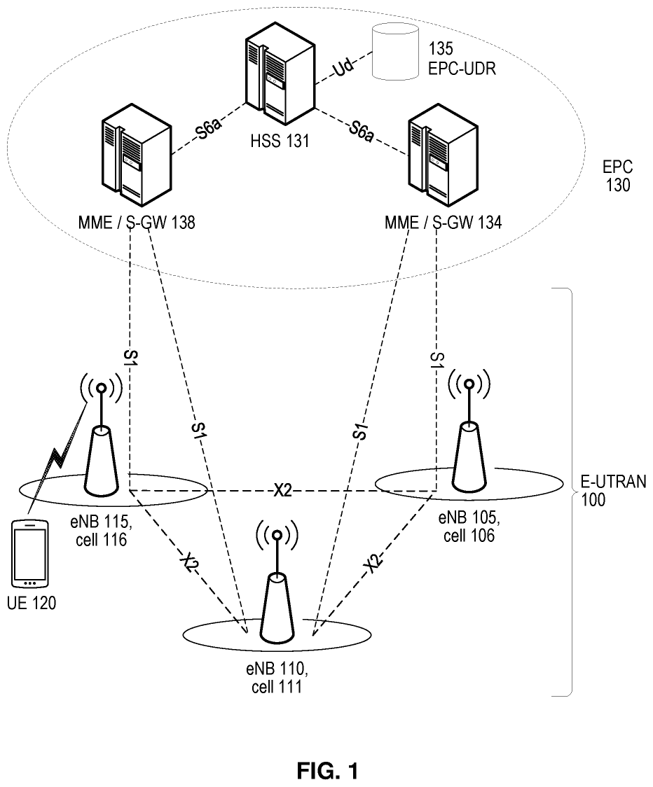

An overall exemplary architecture of a network comprising LTE and SAE is shown in FIG. 1. E-UTRAN 100 includes one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that is capable of communicating with 3GPP-standard-compliant network equipment, including E-UTRAN as well as UTRAN and/or GERAN, as the third-generation (“3G”) and second-generation (“2G”) 3GPP RANs are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. Each of the eNBs can serve a geographic coverage area including one more cells, including cells 106, 111, and 116 served by eNBs 105, 110, and 115, respectively.

The eNBs in the E-UTRAN communicate with each other via the X2 interface, as shown in FIG. 1. The eNBs also are responsible for the E-UTRAN interface to the EPC 130, specifically the S1 interface to the Mobility Management Entity (MME) and the Serving Gateway (SGW), shown collectively as MME/S-GWs 134 and 138 in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. The S-GW handles all Internet Protocol (IP) data packets (e.g., data or user plane) between the UE and the EPC and serves as the local mobility anchor for the data bearers when the UE moves between eNBs, such as eNBs 105, 110, and 115.

EPC 130 can also include a Home Subscriber Server (HSS) 131, which manages user- and subscriber-related information. HSS 131 can also provide support functions in mobility management, call and session setup, user authentication and access authorization. The functions of HSS 131 can be related to the functions of legacy Home Location Register (HLR) and Authentication Centre (AuC) functions or operations. HSS 131 can also communicate with MMES 134 and 138 via respective S6a interfaces.

In some embodiments, HSS 131 can communicate with a user data repository (UDR) -labelled EPC-UDR 135 in FIG. 1—via a Ud interface. EPC-UDR 135 can store user credentials after they have been encrypted by AuC algorithms. These algorithms are not standardized (i.e., vendor-specific), such that encrypted credentials stored in EPC-UDR 135 are inaccessible by any other vendor than the vendor of HSS 131.

The multiple access scheme for the LTE PHY is based on Orthogonal Frequency Division Multiplexing (OFDM) with a cyclic prefix (CP) in the downlink, and on Single-Carrier Frequency Division Multiple Access (SC-FDMA) with a cyclic prefix in the uplink. To support transmission in paired and unpaired spectrum, the LTE PHY supports both Frequency Division Duplexing (FDD) (including both full- and half-duplex operation) and Time Division Duplexing (TDD). The LTE FDD downlink (DL) radio frame has a fixed duration of 10 ms and consists of 20 slots, numbered 0 through 19, each with a fixed duration of 0.5 ms. A 1-ms subframe comprises two consecutive slots where subframe i consists of slots 2i and 2i+1.

3GPP LTE Rel-10 supports bandwidths larger than 20 MHz. One important Rel-10 requirement is backward compatibility with LTE Rel-8, including spectrum compatibility. As such, a wideband LTE Rel-10 carrier (e.g., wider than 20 MHz) should appear as a plurality of carriers (“component carriers” or CCs) to an LTE Rel-8 (“legacy”) terminal. Legacy terminals can be scheduled in all parts of the wideband LTE Rel-10 carrier. One way to achieve this is by Carrier Aggregation (CA), whereby a Rel-10 terminal can receive multiple CCs, each preferably having the same structure as a Rel-8 carrier.

Additionally, LTE Rel-12 introduced dual connectivity (DC) whereby a UE can be connected to two network nodes simultaneously, thereby improving connection robustness and/or capacity. In LTE DC, a UE is configured with a Master Cell Group (MCG) associated with a master eNB (MeNB) and a Secondary Cell Group (SCG) associated with a Secondary eNB (SeNB). Each of the CGs includes a primary cell (PCell) and optionally one or more secondary cells (SCells). The term “Special Cell” (or “SpCell” for short) refers to the PCell of the MCG or the PSCell of the SCG depending on whether the UE's medium access control (MAC) entity is associated with the MCG or the SCG, respectively. In non-DC operation (e.g., CA), SpCell refers to the PCell. An SpCell is always activated and supports physical uplink control channel (PUCCH) transmission and contention-based random access by UEs.

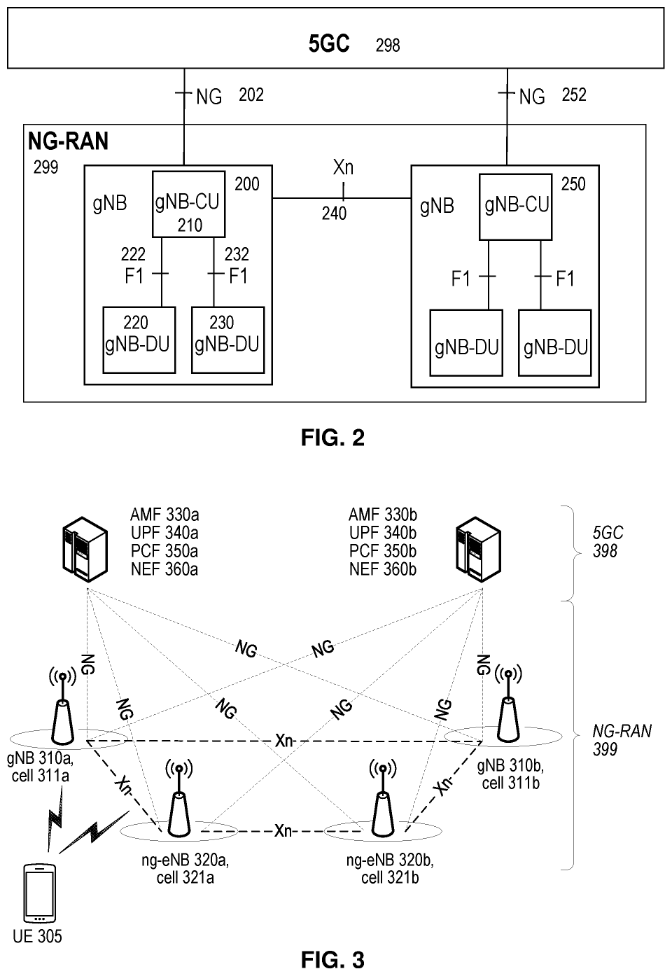

FIG. 2 illustrates a high-level view of the 5G network architecture, consisting of a Next Generation RAN (NG-RAN) 299 and a 5G Core (5GC) 298. NG-RAN 299 can include a set of gNodeB's (gNBs) connected to the 5GC via one or more NG interfaces, such as gNBs 200, 250 connected via interfaces 202, 252, respectively. In addition, the gNBs can be connected to each other via one or more Xn interfaces, such as Xn interface 240 between gNBs 200 and 220. With respect the NR interface to UEs, each of the gNBs can support frequency division duplexing (FDD), time division duplexing (TDD), or a combination thereof.

NG-RAN 299 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an Access and Mobility Management Function (AMF) Region. If security protection for CP and UP data on TNL of NG-RAN interfaces is supported, NDS/IP shall be applied.

The NG RAN logical nodes shown in FIG. 2 include a central (or centralized) unit (CU or gNB-CU) and one or more distributed (or decentralized) units (DU or gNB-DU). For example, gNB 200 includes gNB-CU 210 and gNB-DUs 220 and 230. CUs (e.g., gNB-CU 210) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 222 and 232 shown in FIG. 2. The gNB-CU and connected gNB-DUs are only visible to other gNBs and the 5GC as a gNB. In other words, the F1 interface is not visible beyond gNB-CU. In the gNB split CU-DU architecture illustrated by FIG. 5, DC can be achieved by allowing a UE to connect to multiple DUs served by the same CU or by allowing a UE to connect to multiple DUs served by different CUs.

FIG. 3 shows another high-level view of an exemplary 5G network architecture, including a Next Generation Radio Access Network (NG-RAN) 399 and a 5G Core (5GC) 398.

As shown in the figure, NG-RAN 399 can include gNBs 310 (e.g., 310a,b) and ng-eNBs 320 (e.g., 320a,b) that are interconnected with each other via respective Xn interfaces. The gNBs and ng-eNBs are also connected via the NG interfaces to 5GC 398, more specifically to AMFs (e.g., 330a,b) via respective NG-C interfaces and to User Plane Functions (UPFs, e.g., 340a,b) via respective NG-U interfaces. Moreover, the AMFs 330a,b can communicate with one or more policy control functions (PCFs, e.g., PCFs 350a,b) and network exposure functions (NEFs, e.g., NEFs 360a,b).

Each of the gNBs 310 can support the NR radio interface including frequency division duplexing (FDD), time division duplexing (TDD), or a combination thereof. Each of ng-eNBs 320 can support the LTE radio interface. Unlike conventional LTE eNBs, however, ng-eNBs 320 connect to the 5GC via the NG interface. Each of the gNBs and ng-eNBs can serve a geographic coverage area including one more cells, such as cells 311a-b and 321a-b shown in FIG. 3. Depending on the particular cell in which it is located, a UE 305 can communicate with the gNB or ng-eNB serving that particular cell via the NR or LTE radio interface, respectively. Although FIG. 3 shows gNBs and ng-eNBs separately, it is also possible that a single NG-RAN node provides both types of functionality.

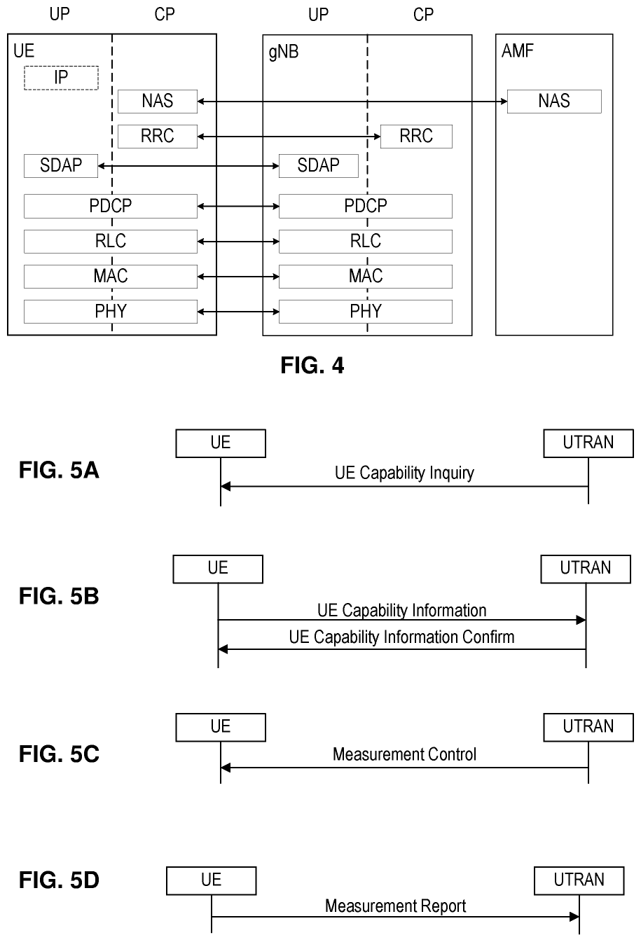

FIG. 4 shows an exemplary configuration of NR user plane (UP) and control plane (CP) protocol stacks between a UE, a gNB, and an AMF, such as those shown in FIGS. 2-3. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. When each IP packet arrives, PDCP starts a discard timer. When this timer expires, PDCP discards the associated SDU and the corresponding PDU. If the PDU was delivered to RLC, PDCP also indicates the discard to RLC.

The RLC layer transfers PDCP PDUs to the MAC through logical channels (LCH). RLC provides error detection/correction, concatenation, segmentation/reassembly, sequence numbering, reordering of data transferred to/from the upper layers. If RLC receives a discard indication from associated with a PDCP PDU, it will discard the corresponding RLC SDU (or any segment thereof) if it has not been sent to lower layers.

The MAC layer provides mapping between LCHs and PHY transport channels, LCH prioritization, multiplexing into or demultiplexing from transport blocks (TBs), hybrid ARQ (HARM) error correction, and dynamic scheduling (on gNB side). The PHY layer provides transport channel services to the MAC layer and handles transfer over the NR radio interface, e.g., via modulation, coding, antenna mapping, and beam forming.

On UP side, the Service Data Adaptation Protocol (SDAP) layer handles quality-of-service (QoS). This includes mapping between QoS flows and Data Radio Bearers (DRBs) and marking QoS flow identifiers (QFI) in UL and DL packets. On CP side, the non-access stratum (NAS) layer is between UE and AMF and handles UE/gNB authentication, mobility management, and security control.

The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of CA and DC configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. in RRC_IDLE state, the UE's radio is active on a discontinuous reception (DRX) schedule configured by upper layers. During DRX active periods (also referred to as “DRX On durations”), an RRC_IDLE. UE receives S1 broadcast in the cell where the LTE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

DC is also envisioned as an important feature for 5G/NR networks. Several DC (or more generally, multi-connectivity) scenarios have been considered for NR. These include NR-DC that is similar to LTE-DC discussed above, except that both the MN and SN (i.e., MgNB and SgNB) employ the NR interface to communicate with the UE. In addition, various multi-RAT DC (MR-DC) scenarios have been considered, whereby a UE can be configured to uses resources provided by two different nodes, one providing E-UTRA/LTE access and the other one providing NR access. One node acts as the MN (e.g., providing MCG) and the other as the SN (e.g., providing SCG), with the MN and SN being connected via a network interface and at least the MN being connected to a core network (e.g., EPC or 5GC).

As briefly mentioned above, Quality of Experience (QoE) measurements have been specified for UEs operating in LTE networks and in earlier-generation UMTS networks. Measurements in both networks operate according to the same high-level principles. Their purpose is to measure the experience of end users when using certain applications over a network. For example, QoE measurements for streaming services and for MTSI (Mobility Telephony Service for IMS) are supported in LTE.

QoE measurements may be initiated towards the RAN from an OAM node generically for a group of UEs (e.g., all UEs meeting one or more criteria), or they may also be initiated from the CN to the RAN for a specific UE. The configuration of the measurement includes the measurement details, which is encapsulated in a container that is transparent to RAN.

A “TRACE START”0 S1AP message is used by the LTE EPC for initiating QoE measurements by a specific UE. This message carries details about the measurement configuration the application should collect in the “Container for application-layer measurement configuration” IE, which transparent to the RAN. This message also includes details needed to reach the TCE to which the measurements should be sent.

FIGS. 5A-D show various procedures between a UMTS RAN (UTRAN) and a UE for QoE measurements in a legacy UMTS network. As shown in FIG. 5A, the UTRAN can send a UE Capability Enquiry message to request the UE to report its application-layer measurement capabilities. As shown in FIG. 5B, the UE can provide its application-layer measurement capabilities to the UTRAN via a UE Capability Information message, particularly in a “Measurement Capability” IE that includes information related to UE capability to perform the QoE measurement collection for streaming services and/or MTSI services. Table 1 below shows exemplary contents of this IE.

TABLE 1

| | | Type and | | |
|---|---|---|---|---|
| IE/Group name | Need | reference | Semantics description | Version |
| QoE Measurement | CV- | Enumerated | TRUE means that the UE | REL-14 |
| Collection for | not_iRAT_HoInfo | (TRUE) | supports QoE | |
| streaming services | | | Measurement Collection | |
| | | | for streaming services. | |
| QoE Measurement | CV- | Enumerated | TRUE means that the UE | REL-15 |
| Collection for MTSI | not_iRAT_HoInfo | (TRUE) | supports QoE | |
| services | | | Measurement Collection | |
| | | | for MTSI services. | |

The UTRAN can respond with a UE Capability Information Confirm message. FIG. 5C shows that the UTRAN can send a Measurement Control message containing “Application-layer measurement configuration” IE in order to configure QoE measurement in the UE. Table 2 below shows exemplary contents of this IE:

TABLE 2

| IE/Group name | Need | Type and reference | Version |
|---|---|---|---|
| Container for | MP | Octet string (1 . . . 1000) | REL-14 |
| application-layer | | | |
| measurement | | | |
| configuration | | | |
| Service type | MP | Enumerated (QoEStreaming, | REL-15 |
| | | QoEMTSI) | |

FIG. 5D shows that the UE can send QoE measurement results via UTRAN to the TCE using a Measurement Report message that includes an “Application-layer measurement reporting” IE. Table 3 below shows exemplary contents of this IE:

TABLE 3

| IE/Group name | Need | Type and reference | Version |
|---|---|---|---|
| Container for | MP | Octet string (1 . . . 8000) | REL-14 |
| application-layer | | | |
| measurement reporting | | | |
| Service type | MP | Enumerated | REL-15 |
| | | (QoEStreaming, | |
| | | QoEMTSI) | |

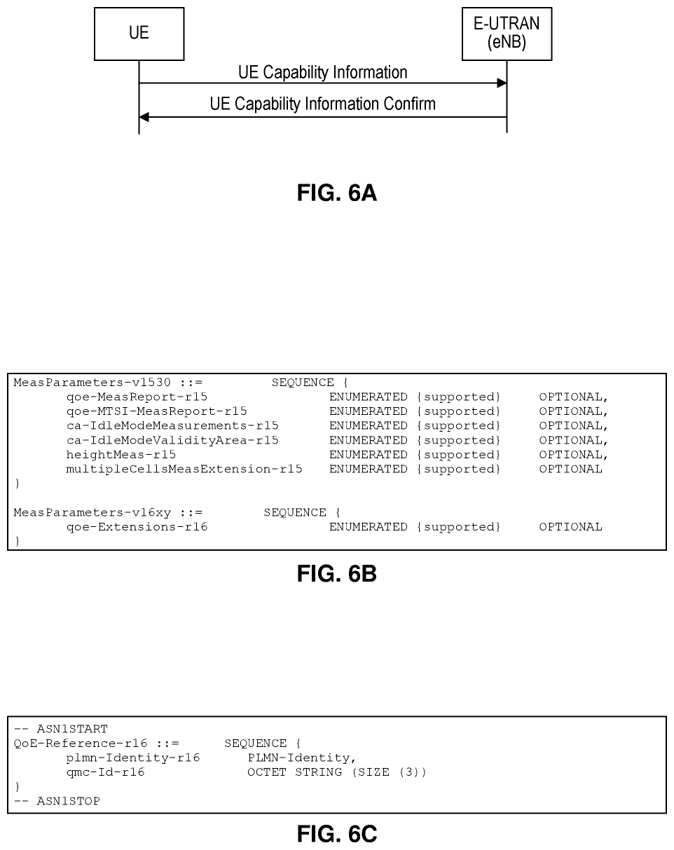

FIGS. 6A-C illustrate a procedure between an E-UTRAN and a UE for configuring QoE measurements in an LTE network. FIG. 6A shows an exemplary UE capability transfer procedure used to transfer UE radio access capability information from the UE to E-UTRAN. Initially, the E-UTRAN can send a UECapabilityEnquiry message, similar to the arrangement shown in FIG. 5A. The UE can respond with a UECapabilityInformation message that includes a “UE-EUTRA-Capability” IE.

This IE may further include a UE-EUTRA-Capability-v1530 IE, which can be used to indicate whether the UE supports QoE Measurement Collection for streaming services and/or MTSI services. In particular, the UE-EUTRA-Capability-v1530 IE can include a measParameter s-v1530 IE containing the information about the UE's measurement support. In some cases, the UE-EUTRA-Capability IE can also include a UE-EUTRA-Capability-v16xy-IE″, which can include a qoe-Extensions-r16 field. FIG. 6B shows an exemplary ASN.1 data structure for these various IEs, with the various fields defined in Table 4 below.

TABLE 4

| Field name | Description |
|---|---|
| qoe-MeasReport | Indicates whether the UE supports QoE Measurement Collection for |
| | streaming services. |
| qoe-MTSI-MeasReport | Indicates whether the UE supports QoE Measurement Collection for |
| | MTSI services. |
| qoe-Extensions | Indicates whether the UE supports the Rel-16 extensions for QoE |
| | Measurement Collection, i.e., support of more than one QoE |
| | measurement type at a time and signaling of withinArea, |
| | sessionRecordingIndication, qoe-Reference, temporaryStopQoE and |
| | restartQoE |
| temporaryStopQoE | Indicates that reporting, but not collection, of QoE measurements |
| | shall be temporarily stopped. |
| withinArea | Indicates at handover, for each application-layer measurement, |
| | whether the new cell is inside the area for the measurement, i.e., |
| | whether the UE is allowed to start new measurements in the cell |
| restartQoE | Indicates that QoE measurements can be reported again after a |
| | temporary stop. |

FIG. 6C shows an exemplary ASN.1 data structure for the qoe-Reference parameter mentioned in Table 4 above.

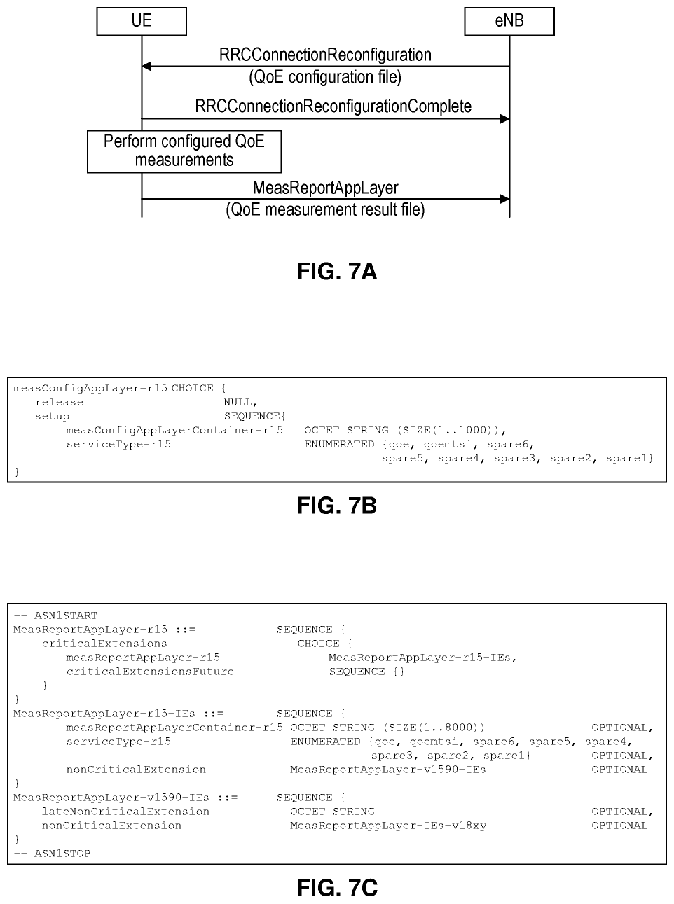

FIGS. 7A-C illustrate various aspects of QoE measurement collection for a UE in an LTE network. In particular, FIG. 7A shows an exemplary signal flow diagram of a QoE measurement collection process for LTE. To initiate QoE measurements, the serving eNB sends to a UE in RRC_CONNECTED state an RRCConnectionReconfiguration message that includes a QoE configuration file, e.g., a measConfigAppLayer IE within an OtherConfig IE. As discussed above, the QoE configuration file is an application-layer measurement configuration received by the eNB (e.g., from EPC) encapsulated in a transparent container, which is forwarded to UE in the RRC message. The UE responds with an RRCConnectionReconfigurationComplete message. Subsequently, the UE performs the configured QoE measurements and sends a MeasReportAppLayer RRC message to the eNB, including a QoE measurement result file. Although not shown, the eNB can forward this result file transparently (e.g., to EPC).

FIG. 7B shows an exemplary ASN.1 data structure for a measConfigAppLayer IE. The setup includes the transparent container measConfigAppLayerContainer which specifies the QoE measurement configuration for the Application of interest. In the service Type field, a value of “qoe” indicates Quality of Experience Measurement Collection for streaming services and a value of “qoemtsi” indicates Enhanced Quality of Experience Measurement Collection for MTSI. This field also includes various spare values.

FIG. 7C shows an exemplary ASN.1 data structure for a measReportAppLayer IE, by which a UE can send to the E-UTRAN (e.g., via SRB4) the QoE measurement results of an application (or service). The service for which the report is being sent is indicated in the service Type IE.

As specified in 3GPP TS 28.405 (v16.0.0), LTE RAN nodes (i.e., eNBs) are allowed to temporarily stop and restart QoE measurement reporting when an overload situation is observed. This behavior can be summarized as follows. In case of overload in RAN, an eNB may temporarily stop UE reporting by sending to relevant UEs an RRCConnectionReconfiguration message with a measConfigAppLayer IE (in otherConfig) set to temporarily stop application-layer measurement reporting. The application stops the reporting and may stop recording further information. When the overload situation in RAN is ended, an eNB may restart UE reporting by sending to relevant UEs an RRCConnectionReconfiguration message with a measConfigAppLayer IE (in otherConfig) set to restart application-layer measurement reporting. The application restarts the reporting and recording if it was stopped.

In general, the RAN (e.g., E-UTRAN or NG-RAN) is not aware of an ongoing streaming session for a UE and nor of when QoE measurements are being performed by the UE. Even so, it is important for the client or management function analyzing the measurements that the entire streaming session is measured. It is beneficial, then, that the UE maintains QoE measurements for the entire session, even during handover situation. However, it is an implementation decision when RAN stops the QoE measurements. For example, it could be done when the UE has moved outside the measured area, e.g., due to a handover.

In addition to QoE measurements, a UE can be configured by the network to perform logged MDT and/or immediate MDT measurements. A UE in RRC_IDLE state can be configured (e.g., via a LoggedMeasurementConfiguration RRC message from the network) to perform periodical MDT measurement logging. An MDT configuration can include logginginterval and loggingduration. The UE starts a timer (T330) set to loggingduration (e.g., 10-120 min) upon receiving the configuration, and perform periodical MDT logging every logginginterval (1.28-61.44 s) within the loggingduration while the UE is in RRC_IDLE state. In particular, the UE collects DL reference signal received strength and quality (i.e., RSRP, RSRQ) based on existing measurements required for cell reselection purposes. The UE reports the collected/logged information to the network when the UE returns to RRC_CONNECTED state.

In contrast, a UE can be configured to perform and report immediate MDT measurements while in RRC_CONNECTED state. Similar to logged MDT, immediate MDT measurements are based on existing UE and/or network measurements performed while a UE is in RRC_CONNECTED, and can include any of the following measurement quantities:
M1: RSRP and RSRQ measurement by UE.
M2: Power Headroom measurement by UE.
M3: Received Interference Power measurement by eNB.
M4: Data Volume measurement separately for DL and UL, per QoS class indicator (QCI) per UE, by eNB.
M5: Scheduled IP layer Throughput for MDT measurement separately for DL and UL, per RAB per UE and per UE for the DL, per UE for the UL, by eNB.
M6: Packet Delay measurement, separately for DL and UL, per QCI per UE, see UL PDCP Delay, by the UE, and Packet Delay in the DL per QCI, by the eNB.
M7: Packet Loss rate measurement, separately for DL and UL per QCI per UE, by the eNB.
M8: received signal strength (RSSI) measurement by UE.
M9: round trip time (RTT) measurement by UE.

For example, the reporting of M1 measurements can be event-triggered according to existing RRM configuration for any of events A1-A6 or B1-B2. In addition, M1 reporting can be periodic, A2 event-triggered, or A2 event-triggered periodic according to an MDT-specific measurement configuration. As another example, the reporting of M2 measurements can be based on reception of Power Headroom Report (PHR), while reporting for M3-M9 can be triggered by the expiration of a measurement collection period.

A new study item for “Study on NR QoE management and optimizations for diverse services” has been approved for NR Rel-17. The purpose is to study solutions for QoE measurements in NR, not only for streaming services as in LTE but also for other services such as augmented or virtual reality (AR/VR), URLLC, etc. Based on requirements of the various services, the NR study will also include more adaptive QoE management schemes that enable intelligent network optimization to satisfy user experience for diverse services.

Similar to LTE, UE QoE measurements made in NG-RAN may be initiated by a management function (e.g., OAM) in a generic way for a group of UEs, or they may be initiated by the core network (e.g., 5GC) towards a specific UE based on signaling with the NG-RAN. As mentioned above, the configuration of the measurement includes the measurement details, which is encapsulated in a container that is transparent to the NG-RAN.

Even so, there are various problems, issues, and/or difficulties with the existing solution for application layer QoE measurements in LTE networks, described above. For example, QoE and radio-layer (e.g., MDT) measurements are collected and/or reported independently and/or without coordination with each other. However, proper analysis of the QoE measurement is not possible without combining and matching application-layer measurement samples with corresponding radio-layer measurement samples and other information provided by the RAN, such as MDT measurements. For example, if QoE measurements are made at different times than radio-layer measurements (e.g., for MDT), it may not be possible to perform a more detailed analysis of the QoE measurements. This can lead to inaccurate or misleading measurement analysis and corresponding inaccurate, improper, and/or sub-optimal network configuration.

U.S. App. 63/046,183 by the present Applicant discloses providing detailed information about radio-layer features and/or duplication/redundancy transmission options used for delivering or retrieving the data for the measured application session to/from the UE. In this application, the radio-layer measurements are triggered by the application layer and included in the application-layer measurement report. However, this may lead to duplication of the radio-related measurements logged by the UE as part of MDT measurement and application-layer measurements.

Accordingly, embodiments of the present disclosure provide techniques that facilitate coordination of application-layer measurements (e.g., QoE measurements) and radio-layer measurements (e.g., MDT measurements) based on parameters such as measurement interval, sampling rate etc. Such techniques can also provide an indication that configured MDT and QoE measurements are coupled and, hence, the respective measurement sampling should be synchronized or aligned.

For example, a unique ID can be used in the coupled MDT and QoE measurement configuration and measurement report, so the entity analyzing the measurements (e.g., OAM or a RAN node) can recognize the coupling. Note that “coupled” MDT and QoE measurements refer to a UE performing MDT measurements at radio layer and QoE measurements at application layer concurrently, e.g., at substantially the same time. For example, both the MDT sample and the QoE sample can be collected within a specified or configured time interval. As another example, the UE can attempt to collect an MDT sample and a QoE sample as close in time as technically feasible, and the analyzing entity can assume more uncertainty the greater the difference between the respective sampling times.

In some embodiments, indications (e.g., AT commands or explicit indications) between the application and radio layers (e.g., access stratum) of the UE can be employed to synchronize or align the measurements. For example, upon indication from the UE application layer to the UE access stratum (or vice versa), the UE logs the radio and application-layer measurements in a coupled way, as discussed above. In some variants, the conditions for sending the indication signal from the UE application layer to the UE access stratum layer (or vice versa) can be configurable by the OAM or RAN node. For example, configured conditions can include when measured QoE metrics are below some predefined threshold values.

In some embodiments, explicit and/or implicit indications between a UE and a RAN node can be used to synchronize and/or align application and/or radio measurements at the UE with radio measurements at the RAN node. For example, an explicit indication can be sent by the UE to the RAN node to indicate that the RAN node should perform and log throughput and latency measurements as part of MDT measurements. As another example, an implicit indication can be a measurement report sent by the UE to the RAN node, which the RAN node can interpret as a request to perform and log throughput and latency measurements as part of MDT measurements.

In some embodiments, an OAM entity can instruct the RAN node (or the UE) through the measurement configuration to record and log the time stamps of the coupled application-layer measurements and radio-layer measurements. Timestamps can be logged at least in one of the coupled measurements. In one variant, the UE can log the timestamp for at least one logged measurement sample.

Embodiments disclosed herein can provide various benefits and/or advantages. For example, embodiments enable the entity (e.g., management system) that analyzes MDT and QoE measurements to couple and merge relevant radio-layer measurements and application-layer measurements in an accurate way, leading to a better network optimization decisions. Moreover, embodiments facilitate matching application layer (e.g., QoE) and radio layer (e.g., MDT) measurement samples logged roughly at the same time in two reports, while avoiding duplication of the radio-layer measurement logging at the application layer. This avoidance of duplication can improve operation of both the UE and the network.

Other advantages include improved observability that provides network operators more extensive and accurate insights into end-user experience and greater control of network compliance with Service Level Agreements (SLAs). Moreover, this improved observability enables more informed decisions in areas such as network design and optimization, service optimization, service offerings, etc.

In the following description of embodiments, the following groups of terms and/or abbreviations have the same or substantially similar meanings and, as such, are used interchangeably and/or synonymously unless specifically noted or unless a different meaning is clear from a specific context of use:
“application layer” and “UE application layer” (RAN nodes generally do not have an application layer);
“application-layer measurement”, “application measurement”, and “QoE measurement”;
“modem”, “radio layer”, “radio network layer”, and “access stratum”;
“MDT measurement”, “radio-layer measurement”, “radio measurement”, and “radio-related measurement”;
“linked”, “synched”, “synchronized”, “associated”, and “coupled” with respect to application-layer measurements and radio-layer measurements;
“service” and “application”;
“measurement collection entity”, “MCE”, “trace collection entity”, and “TCE”.

In general, embodiments disclosed herein are applicable to both signaling- and management-based MDT and QoE measurements. In addition, embodiments disclosed herein are applicable to UEs and RANs used in UMTS, LTE, and NR.

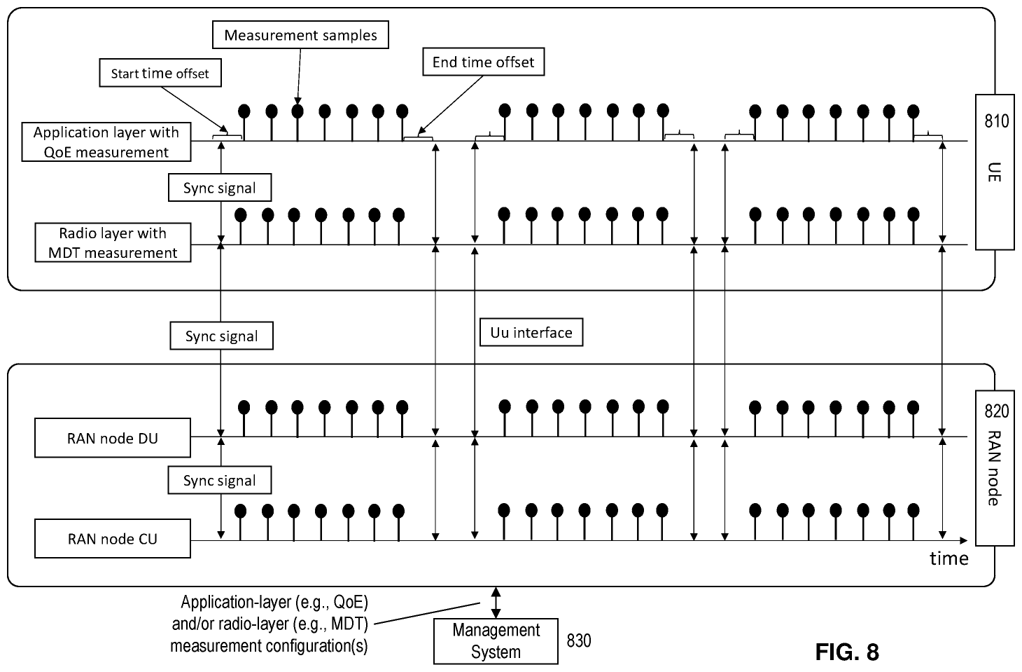

FIG. 8 illustrates exemplary application layer (e.g., QoE) and radio layer (e.g., MDT) measurements by a UE (810) and a RAN node (820), according to various embodiments of the present disclosure. In particular, FIG. 8 illustrates how configuration parameters and sync signals are exchanged between the various entities to provide synched application layer and radio-layer measurements. In addition to sync signals between the UE and the RAN node, FIG. 8 also shows sync signals between UE application layer and radio layer, and between RAN node (e.g., gNB) CU and DU components. Moreover, FIG. 8 illustrates how a management system (830) can provide radio-layer (e.g., MDT) and/or application-layer (e.g., QoE) measurement configurations, including various measurement parameters such as synched measurement interval and duration, common measurement ID, an indication for synched measurements, start and/or end time offsets, and/or target application(s) for synched measurements. These are described below in relation to various embodiments.

In some embodiments, the configuration sent from the management system for radio-layer measurements (e.g., MDT) and application-layer measurements (e.g., QoE) can be enhanced (or being aligned) to enable synchronized measurements between different entities at the UE application layer and radio layer and at the RAN node DU and/or CU. The timing of the measurements can also be based on requirements/factors such as QoE metric definition, configurable/desirable granularity of QoE measurements reports (e.g., QoE measurements reporting per reference time interval, per session, per thread), configurable/desirable aggregation of the radio-layer measurements and QoE measurements (e.g., average, minimum, maximum, deviation (such as standard deviation), per carrier frequency, per RAT), etc.

In some embodiments, the management system can configure a synchronized measurement interval (e.g., sampling rate) and duration. This measurement interval and duration can be the same as the measurement interval and duration of the other measurements that are supposed to be linked with the MDT/trace measurement (e.g., QoE measurements). Note that the application-layer measurement interval (or the sampling rate of the application-layer measurements) can be configured by the management system either as part of QoE configuration file or application-layer measurement configuration IE.

In some embodiments, if there are multiple application-layer measurements associated with different applications/services, a common measurement interval may be selected based on the measurement interval required for the application with the highest measurement sampling rate. Furthermore, the largest required measurement duration amongst those application can be applied. If the rate and interval phase of the multiple application measurements are not coordinated (e.g., resulting in sampling occasions that occur in more complex time patterns than using different subsets of a highest rate of sampling occasions), then the measurement interval may be selected such that a radio layer sample is collected/measured at every sample occasion associated with any of the multiple application measurements. This can imply that the radio layer sampling uses measurement intervals that change for each subsequent interval.

In some embodiments, the measurement interval may be selected based on the measurement interval to be used for the application(s) or service(s) with the measured (or expected) larger variation of at least one QoE metric over a certain time interval or over a certain area. In some embodiments, the measurement interval may be selected to be synchronized with the measurement interval used for the application-layer measurement that is regarded as the most critical/important.

In some embodiments, one radio-layer measurement configuration may be provided for each application-layer measurement or each sampling rate/measurement interval length used for the application-layer measurements. In this manner, there will be a radio-layer measurement configured with a synchronized measurement interval for each application-layer measurement. Optionally, multiple radio-layer measurement configurations (including multiple measurement intervals) can be considered a single configuration, whereby a sequence of measurement samples will be collected in correspondence with the respective measurement interval.

In various embodiments, the measurement interval can be selected based on any of the following, individually or in combination:
QoE measurement interval configured for the application/service whose QoE and MDT measurements are to be coupled or synchronized.
Radio access technology (RAT) in use (e.g., using a less stringent measurement interval in case of LTE and a more stringent measurement interval in case of NR).
At least one of the characteristics of the RAT in use, such as the bearers used for reporting of radio-layer measurements and QoE measurements.
Multi-connectivity configuration used to carry the data for the application session. For instance, for an application session carried over two DC legs (e.g., split bearer), the measurements in either leg may be taken less often, compared to the case where the session is carried via single connectivity.
Prevailing radio conditions or radio environment for the UE. For example, sampling rate for applications running on a fast-moving UE should be generally higher than the sampling rate for a static UE.
Deployment aspects/characteristics, including any of the following:
   Carrier frequency. For instance, high carrier frequencies, e.g., above 30 GHz, for which the radio conditions may vary faster than for lower carrier frequencies, may benefit from shorter measurement intervals.
   Cell size. For instance, smaller cells may imply faster variations in the radio conditions, which in turn may motivate shorter measurement intervals.
   Spatial environment. For instance, if the area in which the measurements area expected to be performed has many obstacles or objects, or a very varying topology, this may imply faster variations in the radio conditions, which in turn may motivate shorter measurement intervals.
In some embodiments, the durations of the application-layer measurement(s) and the radio-layer measurements may be different, as long as one fully overlaps the other. For instance, the duration of the radio-layer measurements may be longer than the duration of the application-layer measurements. Such differences in the measurement durations may be motivated by different (or partly different) purposes of the different measurement types.

In some embodiments, the radio-layer measurement configuration can include a synchronized start time of the measurement. This absolute or relative time can indicate the start time for all the linked and synchronized MDT and QoE measurements. Note that the start time can be valid for measurements related to applications that start their respective sessions after this start time. In such case, the start time can be considered a time when the measurement configuration(s) become valid, such that the UE can be prepared to collect measurement data as soon as a relevant application starts a session (unless a session is already ongoing).

In some embodiments, the MDT configuration for RAN node measurements can include a QoE related event triggering condition. For example, a triggering event can be reception of the QoE measurement report from the UE that includes a “recording session indication” field or IE. In some embodiments, the MDT configuration for UE measurements can include a QoE related event triggering condition. For example, a triggering event can be reception of an indication from the application layer about start of the QoE measurement logging that includes a “recording session indication” field or IE.

In some embodiments, the radio-layer measurement configuration can include an indication that the requested trace or MDT measurements should be linked with at least one of the configured QoE measurements for at least one application. For example, a common ID can be used in the linked measurements, e.g., a trace reference ID that is used for trace/MDT configuration and linked to the QoE configurations and measurements. This common ID can then be included in all Trace, MDT, and QoE measurement reports that are performed in a synchronized manner.

In some embodiments, the radio-layer measurement configuration can include an indication of QoE Reference when configuring MDT measurements. Each MDT session is identified by a measID and the QoE measurements are identified by the QoE Reference. These references do not have to be the same, but they could be configured together and both included when reports are sent so that it is clear that the two measurement sessions are linked. Example implementations are discussed in more detail below.

In some embodiments, the radio-layer measurement configuration can include a start time offset or start time indication of the measurements. This information can be used to inform the other entities to start the measurement at the end of the determined amount of time or at the indicated time. Hence if the application starts a session before this start time indication, synchronized measurements may not be applicable to that session. In some embodiments, the management system can configure an end time offset of the measurements or an end time indication. This information can be used to inform the other entities to stop the measurement at the end of the determined amount of time or at the indicated time.

In various embodiments, the radio-layer measurement configuration can include any of the following:
Target applications' information or their QoE configurations that are supposed to perform the application-layer measurements linked with the radio-layer measurements such as trace or MDT measurements.
An indication that the UE should identify radio resources associated with the applications (and application-layer measurements) in the measurement reports logged by the UE RRC or in relation to the particular applications.
Measurement pause criteria, such that network-based MDT measurements are not performed upon a reception of a QoE measurement report includes the “recording stop/pause indication” and/or UE-based MDT measurements are not performed when the UE radio layer receives a “recording stop/pause indication” from the application layer.

In some embodiments, the radio-layer measurement configuration can include an indication of certain timing information such as absolute time information to be part of the MDT configuration. The network can include this information as part of the MDT configuration to the UE, and UE-generated MDT measurement reports can include the time of performing measurements, e.g., for each sample or for the start of the measurement duration (e.g., complemented by a sampling interval). For example, this time information can be an offset relative to the absolute time information included in the MDT configuration, or it may be one or more absolute time indications (that can be generated based on absolute time information in the MDT configuration). Network-generated MDT measurements can include similar or corresponding time information.

In various embodiments, the management system can configure an enhanced application-layer measurement configuration that can be aligned with various features of the radio-layer measurement configuration discussed above.

In some embodiments, the application-layer measurement configuration can include synchronized measurement interval and duration, which can be the same as the corresponding parameter(s) in the radio-layer measurement configuration. In some embodiments, if there are multiple application-layer measurements associated with different applications/services, a common measurement interval may be selected based on the measurement interval required for the application with the highest measurement sampling rate.

In some embodiments, the application-layer measurement configuration can include a synchronized start time of the QoE measurements. This absolute or relative time can indicate the start time for all the linked MDT and QoE measurements. Note that the start time can be valid for measurements related to applications that start their respective sessions after this start time. In such case, the start time can be considered a time when the measurement configuration(s) become valid, such that the UE can prepared to collect measurement data as soon as a relevant application starts a session (unless a session is already ongoing).

In some embodiments, the application-layer measurement configuration can include an indication that the requested QoE measurements should be linked with at least one of the configured trace or MDT measurements. For example, a common ID can be used in the linked measurements, e.g., UE-associated QoE reference ID that is linked to the trace/MDT configurations and measurements. This common ID can then be included in all Trace, MDT, and QoE measurement reports that are performed in a synchronized manner.

In other embodiments, the application-layer measurement configuration can include an measID (or possibly a Trace Reference) associated with MDT measurements. This is in addition to the conventional QoE Reference and the MDT measurements are identified by a measID or possibly a Trace Reference. These references do not have to be the same, but they could be configured together, and both included in reports so that it is clear that the two measurement sessions are linked. Example implementations are discussed in more detail below.

In some embodiments, the application-layer measurement configuration can include a start time offset or start time indication of the measurements. This information can be used to inform the other entities to start the measurement at the end of the determined amount of time or at the indicated time. In some embodiments, the application-layer measurement configuration can include an end time offset of the measurements or end time indication. This information can be used to inform the other entities to stop the measurement at the end of the determined amount of time or at the indicated time. In some variants, the start time offset and the end time offset can be configured to a common value or to distinct values.

The configuration parameters discussed above (i.e., common ID, start time, start time offset, end time offset, measurement interval, measurement duration) can be selected and/or updated based on any of the following criteria: applications in use, RATs in use, RAN-related information directly or indirectly available at the entity configuring the measurements (e.g., indication of a change in the service capabilities offered by a given network node, total or partial unavailability of a node, loss of synchronization between the node and the operation and maintenance), change of radio conditions due to UE mobility.

In the event of UE mobility between source and target cells, the radio-layer measurements and the QoE measurements can be remain linked by forwarding the configuration parameters in use the source cell to the target cell. Alternatively, the synchronized measurements can be stopped and re-started in the target cell based on a new and/or updated set of configuration parameters applicable to the target cell.

The source and target cells for UE mobility may be served by the same or different RAN nodes and may use the same or different RATs. Continuing the measurements based on the same configuration may be beneficial when the cells use the same RAT. The reason is that it is preferable to avoid interrupting the measurements since measurements covering a complete application session are preferred.

On the other hand, restarting the measurements may be beneficial when the target cell uses a different RAT than the source cell. For example, the types of measurements performed, at least at the radio layer, may have to be changed, such that stopping and restarting the measurements may be a way to achieve reconfiguration while maintaining synchronization between the measurements. As a possible option, only the radio-layer measurements can be stopped, reconfigured, and restarted, while the application-layer measurements can continue running regardless of the mobility event. This possibility may depend on which types of measurements are configured and/or the type of mobility event. For example, an addition of a SCell connectivity leg may require a reconfiguration of an application-layer measurement, whereas a regular handover may not.

Additionally, the configured parameters can be maintained or modified at transition between single connectivity and multi-connectivity (including all forms of DC within and across LTE and NR RATs). For example, measurement sampling can be configured specifically for the new connectivity leg(s), which implies that timing and synchronization parameters for these samples have to be configured, possibly with a different set of parameters than used in single connectivity. Similar reconfigurations may be needed at addition or removal of CCs (or SCells) for CA on existing radio connections (both in DL and UL).

In various embodiments, the application-layer measurement configuration can include any of the following:
Identification of radio-layer measurements that are supposed to be linked with application-layer measurements.
an indication of certain timing information such as absolute time information to be part of the QoE configuration. The network can include this information as part of the QoE configuration to the UE, and UE-generated QoE measurement reports can include the time of performing measurements, e.g., for each sample or for the start of the measurement duration (e.g., complemented by a sampling interval). For example, this time information can be an offset relative to the absolute time information included in the QoE configuration, or it may be one or more absolute time indications (that can be generated to based on absolute time information in the QoE configuration).
A request to transmit an indication to the network when the UE receives an indication such as “recording stop/pause indication” (discussed above) from the application layer.
A request to include the absolute time (obtained as described above) and/or relative time (obtained as described above) of receiving such a notification from the application layer in the QoE report.

In the embodiments discussed above, time information used for linking of measurement sessions and measurement sampling between application-layer measurements and radio-layer measurements may be provided by radio interface time structural references (or radio interface time structural parameters). This includes any combination of hyper frame numbers, system frame numbers (SFNs), subframe numbers, slot numbers, and symbol numbers. Alternatively, absolute time indications such as UTC may be used individually or in combination with the radio interface time structural references.

The start and end of measurement sessions may be determined by the start and end of application sessions associated with the relevant application-layer measurement(s). For instance, the start of an application session may trigger the start of the application-layer measurements which in turn triggers the start of the radio-layer measurement, with a corresponding mechanism for ending the measurement sessions based on the end of the application session. In some embodiments, the radio-layer measurements may be continuously running from some time before the start of a relevant application session and until sometime after the application session has ended. In contrast, the application-layer measurements are started and ended in alignment with the application session.

In such a case, the radio layer and application-layer measurement durations are not the same. Even so, the sampling occasions can be concurrent. Since the radio-layer measurements are already running when the application-layer measurement is started, the application-layer measurement can adapt its sampling occasions to those of the radio-layer measurement. Adapting the sampling occasions of the already running radio-layer measurement (e.g., changing sampling rate and/or sampling phase) to align with a newly started application-layer measurement is also possible.

Various embodiments also provide signaling between application and different entities of the network to maintain coupling or linking (e.g., in terms of sampling occasions and/or measurement sessions) between application layer and radio-layer measurements. The signaling can include the information discussed above in relation to other embodiments (e.g., a common ID that links the radio and QoE measurements).

In some embodiments, signaling from the UE application layer to the UE radio layer can include a start signal indicated by an AT command. Some variants can also include one or more configuration parameters that indicate when to start linked radio-layer measurements, such as start time offset and/or any other relevant timing-related parameters discussed above. In other variants, the start signal from the application layer can trigger the radio layer to start the linked radio-layer measurements immediately (i.e., as soon as technically feasible after receipt).

In some embodiments, signaling from the UE application layer to the UE radio layer can include a stop signal indicated by an AT command. Some variants can also include one or more configuration parameters that indicate when to stop linked radio-layer measurements, such as end time offset and/or any other relevant timing-related parameters discussed above. In other variants, the stop signal from the application layer can trigger the radio layer to stop the linked radio-layer measurements immediately.

In some embodiments, signaling from the UE application layer to the UE radio layer can include a suspend signal indicated by an AT command. Some variants can also include one or more configuration parameters that indicate when to suspend linked radio-layer measurements, such as a suspend time offset and/or any other relevant timing-related parameters discussed above. In other variants, the suspend signal from the application layer can trigger the radio layer to suspend the linked radio-layer measurements immediately.

In some embodiments, signaling from the UE application layer to the UE radio layer can include a suspend duration indicated by an AT command. The suspension duration can be a period during which the linked measurements should be suspended and can be expressed in terms of radio interface time structural parameters, absolute time references (e.g., suspend start/end times), or some absolute duration (e.g., milliseconds). In some embodiments, the suspend duration can be combined with the suspend signal discussed above.

In some embodiments, signaling from the UE application layer to the UE radio layer can include a restart/resume signal indicated by an AT command. Some variants can also include one or more configuration parameters that indicate when to restart/resume linked radio-layer measurements, such as a resume time offset and/or any other relevant timing-related parameters discussed above. In other variants, the restart/resume signal from the application layer can trigger the radio layer to restart/resume the linked radio-layer measurements immediately.

In some embodiments, signaling from the UE application layer to the UE radio layer can include an indication of which radio-layer measurements should be started, stopped, suspended, restarted, or resumed. This indication may be an ID that is common for the linked application layer and radio-layer measurements. The indication may be included with or in any of the other signals discussed above.

In some embodiments, signaling from the UE radio layer to the UE application layer can to include a start signal indicated by an AT command. Some variants can also include one or more configuration parameters that indicate when to start linked application-layer measurements, such as start time offset and/or any other relevant timing-related parameters discussed above. In other variants, the start signal from the radio layer can trigger the application layer to start the linked application-layer measurements immediately.

As an alternative, the start signal can indicate that the radio layer is prepared and ready to start linked radio-layer measurements whenever an application associated with the linked application-layer measurements initiates a session. The application layer can provide an indication of this event, which can trigger the radio layer to initiate the measurements.

In some embodiments, signaling from the UE radio layer to the UE application layer can include a stop signal indicated by an AT command. Some variants can also include one or more configuration parameters that indicate when to stop linked application-layer measurements, such as stop time offset and/or any other relevant timing-related parameters discussed above. In other variants, the stop signal from the radio layer can trigger the application layer to stop the linked application-layer measurements immediately.

In some embodiments, signaling from the UE radio layer to the UE application layer can include a restart/resume signal indicated by an AT command. Some variants can also include one or more configuration parameters that indicate when to restart/resume (previously suspended) linked application-layer measurements, such as resume time offset and/or any other relevant timing-related parameters discussed above. In other variants, the restart/resume signal from the radio layer can trigger the application layer to restart/resume the linked application-layer measurements immediately.

In some embodiments, signaling from the UE radio layer to the UE application layer can include a suspend signal indicated by an AT command. Some variants can also include one or more configuration parameters that indicate when to suspend linked application-layer measurements, such as suspend time offset and/or any other relevant timing-related parameters discussed above. In other variants, the suspend signal from the radio layer can trigger the application layer to suspend the linked application-layer measurements immediately.

In some embodiments, signaling from the UE application layer to the UE radio layer can include a suspend duration indicated by an AT command. The suspension duration can be a period during which the linked measurements should be suspended and can be expressed in terms of radio interface time structural parameters, absolute time references (e.g., suspend start/end times), or some absolute duration (e.g., milliseconds). In some embodiments, the suspend duration can be combined with the suspend signal discussed above.

In some embodiments, signaling from the UE radio layer to the UE application layer can include an indication of which application-layer measurements should be started, stopped, suspended, restarted, or resumed. This indication may be an ID that is common for the linked application layer and radio-layer measurements. The indication may be included with or in any of the other signals discussed above.

In various embodiments, the signaling between application and radio layers can be done periodically, aperiodically, or semi-periodically. In periodic embodiments, one entity (e.g., application layer or radio layer) sends synchronization signals at predetermined periodic time instances to inform the other entity (e.g., radio layer or application layer) about the measurement status. This synchronization signal can be any of those discussed above, e.g., as indicated by respective AT commands.

In aperiodic embodiments, one entity (e.g., application layer or radio layer) sends synchronization signals when a measurement should be performed at a certain time, when some action related to the measurement is needed (e.g., start, stop, etc.), or when a change to a property of the measurement is needed (e.g., changing sampling rate).

In semi-periodic embodiments, one entity (e.g., application layer or radio layer) sends a synchronization signal when a measurement should be performed at a certain time, and then sends additional synchronization signals at predetermined periodic time instances to inform the other entity (e.g., radio layer or application layer) about the measurement status.

In some embodiments, the UE's configured radio-layer measurements can be performed conditionally based on performing configured QoE measurement at application layer. Hence the MDT measurement configuration received by the UE should be suspended until performing the QoE measurement on the relevant application. Any ongoing UE MDT measurement that is not coupled with a QoE measurement may continue until this moment and may be suspended only upon starting a new synchronized measurement.

In some embodiments, the UE's configured QoE measurement at application layer can be performed conditionally based on the network performing configured MDT measurement. Hence the QoE measurement configuration received by the UE should be suspended until performing the MDT measurement at network side. Any ongoing MDT measurement that is not coupled with QoE measurement is suspended upon receiving such configuration and measurement using new configuration starts.

In some embodiments, RAN nodes can also perform radio-layer measurements such as throughput, latency, packet loss rate, etc. As such, it can be beneficial to align these radio-layer measurements at the RAN node and UE application-layer measurements at the, e.g., to provide similar benefits as when UE application and radio-layer measurements are synchronized. According, certain embodiments include signaling between a UE and a RAN node (including DU and/or CU) to provide such beneficial synchronized measurements.

In some embodiments, measurement linking between the RAN node and UE (at RRC layer or application layer) is done via implicit signaling. For example, the RAN node measures throughput, delay, packet loss rate, etc. when it receives the UE QoE or MDT measurements.

In some embodiments, measurement linking between RAN node and UE (at RRC layer or application layer) is done via explicit signaling. For example, the UE can explicitly indicate that the RAN node should perform measurements of throughput, latency, packet loss rate, etc. The indication can include an absolute or relative time that the measurement should be made by the RAN node, and/or any of the configuration information discussed above in relation to various embodiments.

In some embodiments, the RAN node is aware of the QoE measurement sampling configuration and adapts its own measurement sampling accordingly to achieve linked sampling. As one option, the UE can indicate to the RAN node when it starts a QoE measurement session having a dynamic start time, e.g., the QoE measurement was not configured to start immediately upon reception of the QoE measurement configuration in the UE or a certain start time. For example, this can occur at the start of an application session associated with the QoE measurement. As another option, the RAN node may itself discover when such an application session is started based on inspection of the packets sent to and from the UE (e.g., looking at the TCP port numbers) and/or on explicit or implicit indications of application session initiations from the CN (e.g., 5GC).

In some embodiments, the RAN node can become aware of the relevant aspects of the UE's QoE measurement by interpreting the QoE measurement configuration when it is received from the management system or the CN. As another option, the UE signals the relevant aspects of the QoE measurement configuration to the RAN node (which may involve transferring them between the application layer and the radio layer in the UE). For example, the RAN node may request this information using the UEInformationRequest RRC message and the UE includes the requested information in the UEInformationResponse RRC message.

Although the above description is based on the RAN node performing MDT measurements, these can be replaced and/or augmented with proprietary measurements.

It is possible to apply principles and mechanisms described herein for linking of multiple application-layer measurements (e.g., QoE measurements associated with simultaneously active applications) to radio-layer measurements. This may be achieved by separate configurations (including the parameters providing the means for synchronization) per application or QoE measurement, or by configuring a single radio-layer measurement configuration to collect measurement samples that are synchronized with all the relevant QoE measurements.

One way to link (e.g., in terms of sampling occasions and/or start/stop times of measurement sessions) radio-layer measurements with multiple active application-layer measurements is to provide one radio-layer measurement configuration for each of the relevant QoE measurement configurations. Then, for each pair of application-layer measurement configuration and radio-layer measurement configuration, any of the above-described techniques for achieving linking between the measurements can be used. The multiple application-layer measurements and the multiple radio-layer measurements can then run in parallel but independent of each other, with each radio-layer measurement being linked with a different one of the application-layer measurements.

In other embodiments, a single radio-layer measurement configuration can be common to (and linked with) all application-layer measurement configurations. Consider an example with first and second applications with respective first and second application-layer measurements (e.g., QoE measurements). The first and the second application-layer measurement have different sampling intervals (e.g., length and/or phase) and may be different measurement types or measurement quantities.

A common radio-layer measurement configuration can be provided that ensures that each sample of the first application-layer measurement is concurrent with a sample of the radio-layer measurement, even if the radio-layer measurements also may collect further samples in between the concurrent samples. Furthermore, the common radio-layer measurement configuration can also ensure that each sample of the second application-layer measurement always is concurrent with a sample of the radio-layer measurement, even if the radio-layer measurements also may collect further samples in between the concurrent samples.

As one option, every sampling occasion of the common radio-layer measurement configuration is concurrent with a sampling occasion of either the first or the second application-layer measurement configuration. Alternately, the common radio-layer measurement configuration may have further sampling occasions (and thus collect further samples) that are not concurrent with samples of the first or the second application-layer measurement configurations—so long as each sample of the first and second application-layer measurement configurations has a concurrent sample in the radio-layer measurement configuration.

This can be achieved by including two different sampling configurations (e.g., in terms of sampling interval length and phase/offset) in the radio-layer measurement configuration—one corresponding to each of the application-layer measurement configuration—that are combined into a common sampling pattern. This can also be achieved by including in the radio-layer measurement configuration a sampling rate that is a common multiple of the sampling rates of the first and second application-layer measurement configurations, and aligning the sampling phases the first and second application-layer measurement configurations for periodic concurrence. For instance, if the first application-layer measurement has a sampling rate of 2 samples per second and the second application-layer measurement has a sampling rate of 5 samples per second, the single common radio-layer measurement could be configured with a sampling rate of 10 samples per second.

Similar principles can be applied to link a common application-layer measurement configuration with first and second radio-layer measurement configurations. Moreover, such principles can be easily extended to any type of one-to-many relationships among measurement configurations, e.g., for synchronizing a common radio-layer measurement configuration with N different application-layer measurement configurations. Additionally, similar principles can be applied to synchronize more than two different types of measurement configurations, e.g., radio layer, application layer, and one or more other types.

Furthermore, although the above description is based on adapting sampling in one type of measurement configuration to match sampling in another type of measurement configuration, both types can also be adapted (e.g., in terms of sampling rate and/or phase) jointly to obtain a linked sampling configuration This can be done by a single entity, e.g., in the management system.

The above description is based generally on the assumption that MDT is unaware of service type. This means that even MDT measurements coupled with QoE measurements are performed on traffic including but not limited to the traffic associated with the measured application(s). In other words, if a UE runs two applications at the same time, it is not possible to distinguish whether MDT measurement samples pertain to a particular application or possibly both applications.

In some embodiments, the UE application layer can provide the UE radio layer identifying information for multiple applications running concurrently, such as TCP or other port numbers. Based on traffic filters used to direct application layer data to UL DRBs, the radio layer can then determine which data belongs to each application and perform radio-layer measurements only on application data associated with linked QoE measurements.

In some embodiments, MDT measurements made on each DRB (or other radio resource) can be associated with traffic of a particular application having linked QoE measurements based on labeling or indexes indicating the application or the service type. In one variant, the UE radio layer can compile a list of measurements per DRBs, each pertaining to one application or service type. In another variant, the UE only indicates which DRBs are linked to which applications. The RAN node may use this information to perform MDT measurements per DRB associated/linked to the applications/services.

In some embodiments, the RAN node radio layer may obtain information about which applications are using which DRBs through packet inspection (e.g., checking TCP port numbers in the data flow) or based on explicit or implicit indications. The radio layer can also obtain information about which applications are using which DRBs based on pre-configuration by the management system. For example, a pre-configuration may indicate to the radio layer which DRB IDs are used for which applications.

In some embodiments, the radio layer (at UE and/or RAN) is service-aware and can extract MDT measurements for a service whose MDT and QoE measurements are coupled. In other embodiments, where the UE radio layer is oblivious to the service type, upon receiving a packet pertaining to a certain service type, the UE application layer indicates the service association of the packet to the radio layer. The radio layer then associates the MDT measurement of resources used by the packet with the indicated service type, e.g., in a separate MDT log for this service type.

As an alternative to control signaling between radio and application layers via AT command, discussed above, the application layer (or radio layer) can append a measurement control indication (e.g., start, stop, suspend, resume) to a data packet being transferred to the radio layer (or application layer). This can be referred to as a “triggering packet”. In one variant, the measurement duration starts at the arrival time of the triggering packet. This accounts for that packets do not arrive at the radio layer and application layer continuously, and that a packet does not arrive at the radio layer and the application layer at the simultaneously. For example, UL packets are first processed at the radio layer and then at the application layer, while DL packets are first processed at the application layer and then at the radio layer.

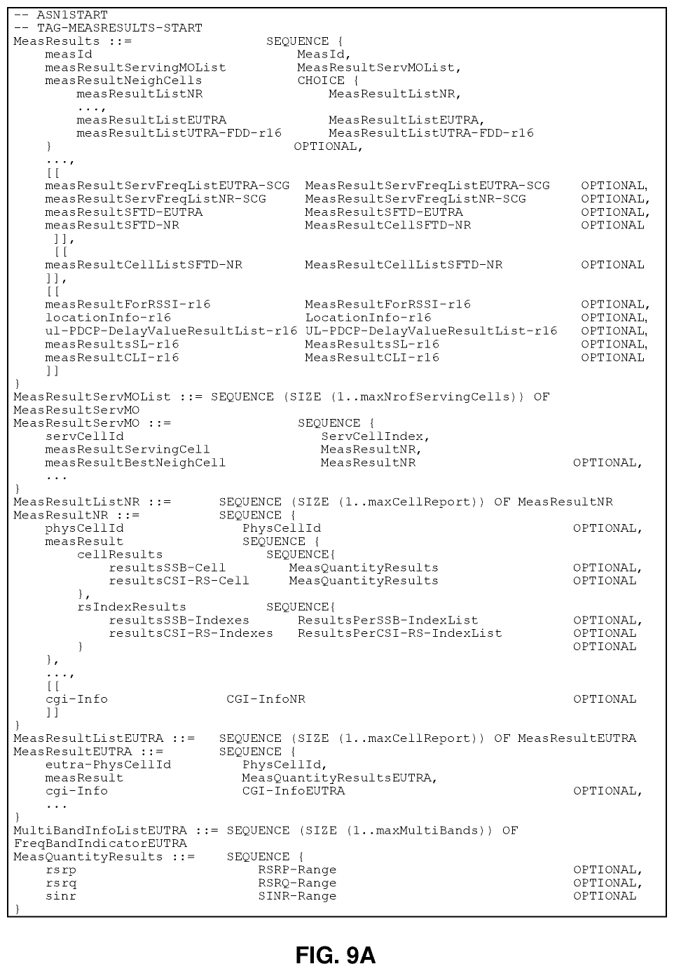

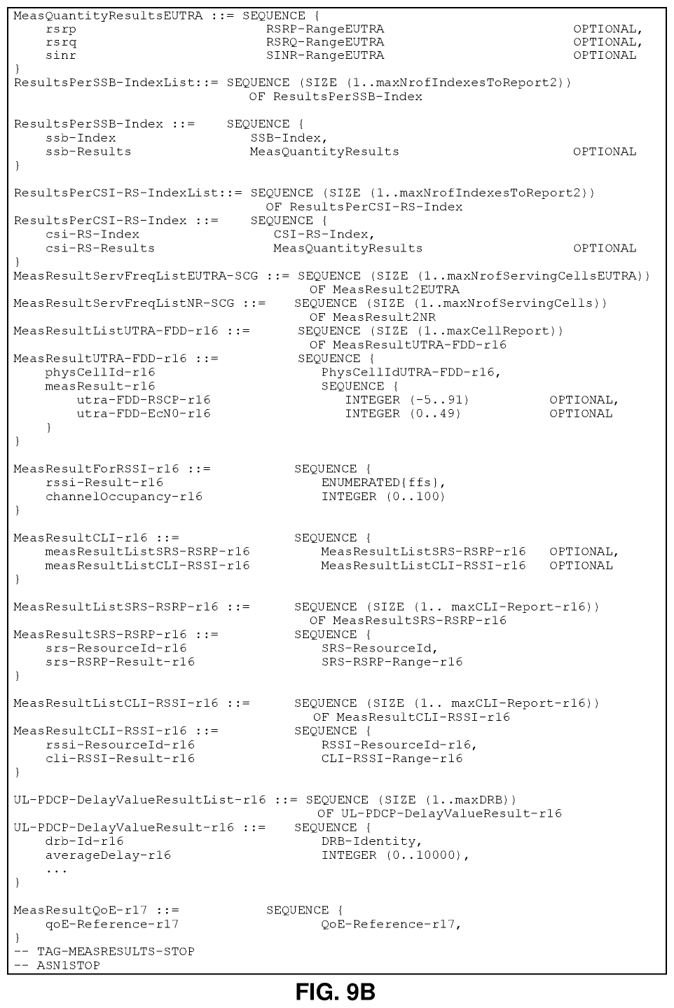

FIG. 9, which includes FIGS. 9A-B, shows an exemplary ASN.1 data structure for a MeasResult IE by which a UE can send a QoE Reference together with MDT measurements, according to various embodiments of the present disclosure. In particular, FIG. 9 is an extension of an existing MeasResult IE (defined in 3GPP TS 38.331 v16.2.0) to include an additional MeasResultQoE-r17 IE, which includes a QoE-Reference-r17 field with relevant information. From the QoE-Reference-r17 included with the MDT measurements, the receiving entity can infer that these MDT measurements are associated with QoE measurements corresponding to the QoE-Reference-r17.

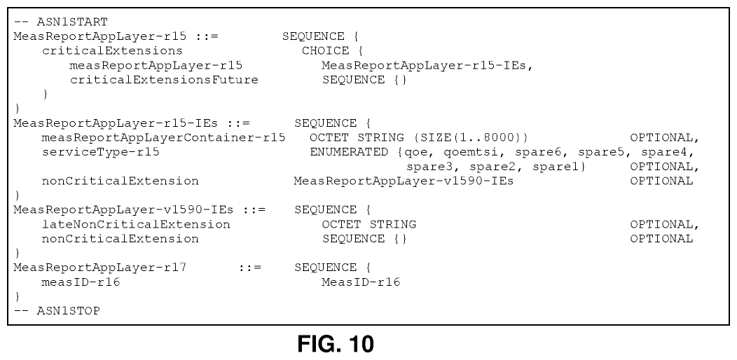

FIG. 10 shows an exemplary ASN.1 data structure for a MeasReportAppLayer IE by which a UE can send a MeasID reference together with QoE measurements, according to various embodiments of the present disclosure. As discussed above, each MDT session is identified by a particular measID. In particular, FIG. 10 is based on the exemplary LTE MeasReportAppLayer IE shown in FIG. 7C. From the MeasID included with the QoE measurements, the receiving entity can infer that these QoE measurements are associated with MDT measurements corresponding to the MeasID.

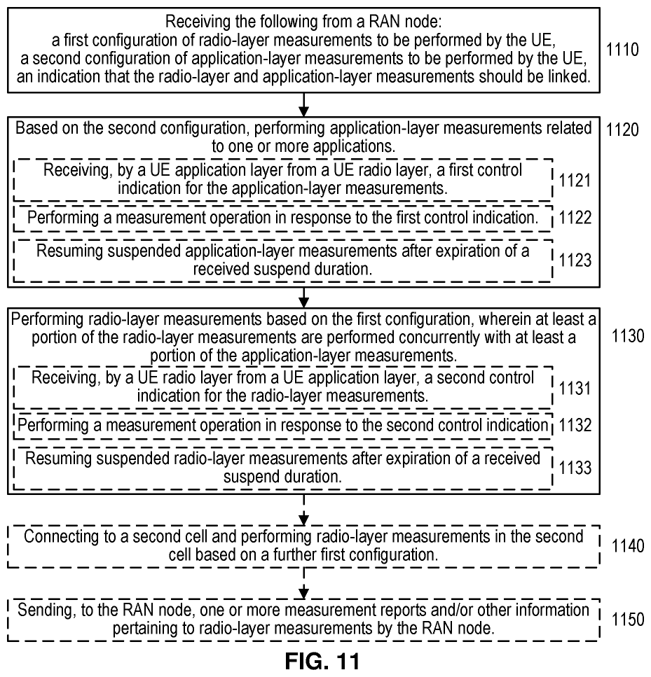

The embodiments described above can be further illustrated with reference to FIGS. 11-13, which show exemplary methods (e.g., procedures) for a UE, a RAN node, and a network node or function coupled to the RAN, respectively. Put differently, various features of the operations described below correspond to various embodiments described above. The exemplary methods shown in FIGS. 11-13 can be used cooperatively to provide various exemplary benefits and/or advantages. Although FIGS. 11-13 shows specific blocks in particular orders, the operations of the exemplary methods can be performed in different orders than shown and can be combined and/or divided into blocks having different functionality than shown. Optional blocks or operations are indicated by dashed lines.

In particular, FIG. 11 shows a flow diagram of an exemplary method (e.g., procedure) to perform radio-layer and application-layer measurements in a RAN, according to various embodiments of the present disclosure. The exemplary method can be performed by a UE (e.g., wireless device, IoT device, modem, etc. or component thereof) such as described elsewhere herein.

The exemplary method can include operations of block 1110, where the UE can receive the following from a RAN node:
a first configuration of radio-layer measurements to be performed by the UE,
a second configuration of application-layer measurements to be performed by the UE, and
an indication that the radio-layer measurements and the application-layer measurements should be linked.
   The exemplary method can also include operations of block 1120, where the UE can, based on the second configuration, perform application-layer measurements related to one or more applications. The exemplary method can also include operations of block 1130, where the UE can perform radio-layer measurements based on the first configuration, wherein at least a portion of the radio-layer measurements are performed concurrently with at least a portion of the application-layer measurements.

In some embodiments, the radio-layer measurements can be MDT or trace measurements, while the application-layer measurements can be QoE measurements.

In some embodiments, performing the application-layer measurements in block 1120 can include the operations of sub-blocks 1121-1122. In sub-block 1121, a UE application layer can receive from a UE radio layer one of the following first control indications for the application-layer measurements: a first start indication, a first stop indication, a first suspend indication, and a first resume indication. In sub-block 1122, the UE (e.g., the application layer) can perform one of the following operations in response to the received first control indication:
initiating the application-layer measurements in response to the first start indication;
to stopping ongoing application-layer measurements in response to the first stop indication;
suspending ongoing application-layer measurements in response to the first suspend indication; and
resuming suspended application-layer measurements in response to the first resume indication.

In some embodiments, the first suspend indication includes a suspend duration. In such embodiments, the operations of block 1120 can include the operations of sub-block 1123, where the UE (e.g., the application layer) can resume suspended application-layer measurements after expiration of the received suspend duration.

In some embodiments, the first control indication can be received in association with an identification of at least one application, of the one or more applications, to which the first control indication applies. In such embodiments, the responsive operation (e.g., in sub-block 1122) can be performed only on the identified at least one application. In some embodiments, the first control indication can be received by the UE application layer in association with a data packet from the UE radio layer.

In some embodiments, performing the radio-layer measurements in block 1130 can include the operations of sub-blocks 1131-1132. In sub-block 1131, the UE radio layer can receive from a UE application layer one of the following second control indications for the radio-layer measurements: a second start indication, a second stop indication, a second suspend indication, and a second resume indication. In sub-block 1132, the UE (e.g., the radio layer) can perform one of the following operations in response to the received second control indication:
initiating the radio-layer measurements in response to the second start indication;
stopping ongoing radio-layer measurements in response to the second stop indication;
suspending ongoing radio-layer measurements in response to the second suspend indication; and
resuming suspended radio-layer measurements in response to the second resume indication.

In some embodiments, the second suspend indication includes a suspend duration. In such embodiments, the operations of block 1130 can include the operations of sub-block 1133, where the UE (e.g., the radio layer) can resume suspended radio-layer measurements after expiration of the received suspend duration.

In some embodiments, the second control indication can be received by the UE radio layer in association with a data packet from the UE application layer.

In various embodiments, the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.
   In various embodiments, the first configuration can include one or more of the following:
a pause criterion for the radio-layer measurements that is related to the application-layer measurements,
a first absolute time,
a time offset relative to a second absolute time included in the second configuration,
an indication that radio-layer measurement reports should include associations between radio resources and particular applications, and
   a request to inform the RAN node when the UE radio layer receives a first control indication from the UE application layer.
   In various embodiments, the second configuration can include one or more of the following:
a pause criterion for the application-layer measurements that is related to the radio-layer measurements,
a second absolute time,
a time offset relative to a first absolute time included in the first configuration, and
an indication that application-layer measurement reports should include associations between radio resources and particular applications.

In some embodiments, the radio-layer measurements can be performed based on the first configuration while the UE is operating in a first cell. In such embodiments, the exemplary method can also include the operations of block 1140, where the UE can connect to a second cell and perform radio-layer measurements in the second cell based on a further first configuration (e.g., received via the second cell). In such embodiments, the application-layer measurements can be performed in the first and second cells based on the (same) second configuration.

In some embodiments, the exemplary method can also include the operations of block 1150, where the UE can send, to the RAN node, one or more of the following:
one or more measurement timing parameters included in the second configuration,
a first measurement report related to the performed radio-layer measurements,
a second measurement report related to the performed application-layer measurements,
an indication that the UE initiated the application-layer measurements,
a request to perform radio-layer measurements at the RAN node, and
an absolute or relative time at which the RAN node should perform radio-layer measurements.

In some embodiments, the one or more applications include a plurality of applications and the second configuration includes a corresponding plurality of second configurations for the plurality of applications (i.e., one configuration per application). In some of these embodiments, the first configuration includes a corresponding plurality of first configurations associated with the respective plurality of second configurations.

In other of these embodiments, the first configuration is associated with the plurality of applications and is related to the respective second configurations based on one or more of the following:
a first sampling rate that is a common multiple of respective second sampling rates, and
each first sampling occasion is concurrent with a second sampling occasion associated with one of the plurality of second configurations.

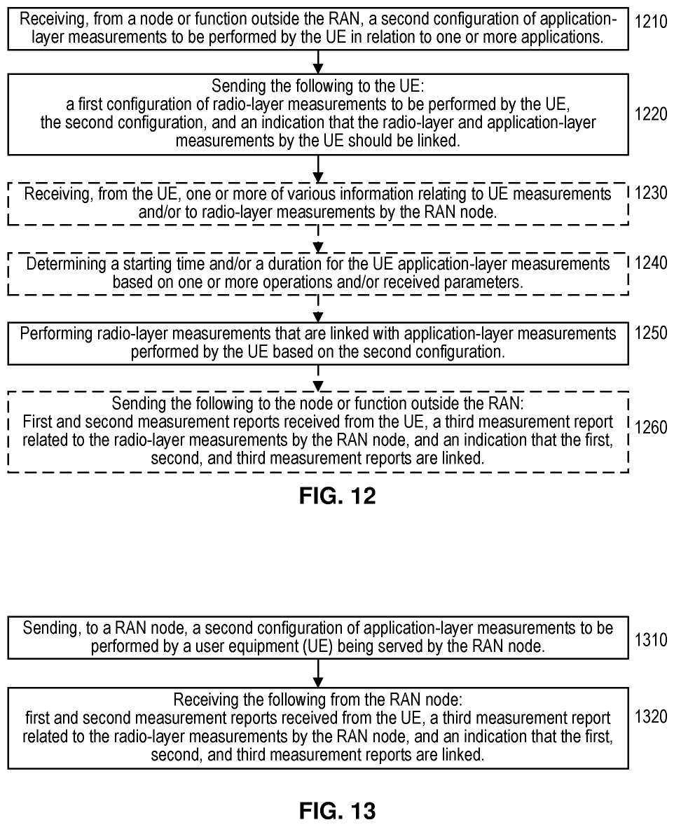

In addition, FIG. 12 shows a flow diagram of an exemplary method (e.g., procedure) to configure a UE to perform radio-layer and application-layer measurements, according to various embodiments of the present disclosure. The exemplary method can be performed by a RAN node (e.g., base station, eNB, gNB, ng-eNB, etc., or components thereof) such as described elsewhere herein.

The exemplary method can include the operations of block 1210, where the RAN node can receive, from a network node or function outside the RAN, a second configuration of application-layer measurements to be performed by the UE in relation to one or more applications. The exemplary method can also include the operations of block 1220, where the RAN node can send the following to the UE:
a first configuration of radio-layer measurements to be performed by the UE,
the second configuration, and
an indication that the radio-layer and application-layer measurements by the UE should be linked.
   The exemplary method can also include operations of block 1250, where the RAN node can perform radio-layer measurements that are linked with application-layer measurements performed by the UE based on the second configuration.

In some embodiments, the radio-layer measurements performed by the UE can be MDT or trace measurements, while the application-layer measurements performed by the UE can be QoE measurements.

In some embodiments, the indication that the radio-layer measurements and the application-layer measurements should be linked is received from the network node or function outside of the RAN (e.g., OAM, AMF, etc.). In various embodiments, the indication that the radio-layer and application-layer measurements by the UE should be linked can include one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.
   In various embodiments, the first configuration can include one or more of the following:
a pause criterion for the UE radio-layer measurements that is related to the application-layer measurements,
a first absolute time,
a time offset relative to a second absolute time included in the second configuration,
an indication that UE radio-layer measurement reports should include associations between radio resources and particular applications, and
a request to inform the RAN node when the UE radio layer receives a first control indication from the UE application layer.
   In various embodiments, the second configuration can include one or more of the following:
a pause criterion for the UE application-layer measurements that is related to the UE radio-layer measurements,
a second absolute time,
a time offset relative to a first absolute time included in the first configuration, and
an indication that UE application-layer measurement reports should include associations between radio resources and particular applications.

In some embodiments, the exemplary method can also include the operations of block 1240, where the RAN node can receive, from the UE, one or more of the following:
one or more measurement timing parameters included in the second configuration,
a first measurement report related to UE radio-layer measurements,
a second measurement report related to UE application-layer measurements,
an indication that the UE initiated the application-layer measurements,
a request to perform radio-layer measurements at the RAN node, and
an absolute or relative time at which the RAN node should perform radio-layer measurements.
   In such embodiments, performing the radio-layer measurements (e.g., in block 1250) can be responsive to one of the following:
the second measurement report,
the indication that the UE initiated the application-layer measurements, or
the request to perform radio-layer measurements at the RAN node.

In some of these embodiments, the exemplary method can also include the operations of block 1260, where the RAN node can send the following to the network node or function outside the RAN:
the first measurement report,
the second measurement report,
a third measurement report related to the radio-layer measurements performed by the RAN node, and
an indication that at least one of the first and third measurement reports is linked to the second measurement report.

In some embodiments, the exemplary method can also include the operations of block 1240, where the RAN node can determine a starting time and/or a duration for the UE application-layer measurements based on one or more of the following:
inspection of the second configuration received from the network node or function outside the RAN,
one or more measurement timing parameters included in the second configuration, as received from the UE,
inspection of application session initiation messages forwarded by the RAN node to or from the UE, and
inspection of application session data packets forwarded by the RAN node to or from the UE.
   In such embodiments, the radio-layer measurements can be performed (e.g., in block 1250) based on the determined starting time and/or the determined duration for the UE application-layer measurements.

In some embodiments, the one or more applications include a plurality of applications and the second configuration includes a corresponding plurality of second configurations for the plurality of applications (i.e., one configuration per application). In some of these embodiments, the first configuration includes a corresponding plurality of first configurations associated with the respective plurality of second configurations.

In other of these embodiments, the first configuration is associated with the plurality of applications and is related to the respective second configurations based on one or more of the following:
a first sampling rate that is a common multiple of respective second sampling rates, and
each first sampling occasion is concurrent with a second sampling occasion associated with one of the plurality of second configurations.

In addition, FIG. 13 shows a flow diagram of an exemplary method (e.g., procedure) for a network node or function coupled to a RAN, according to various embodiments of the present disclosure. For example, this exemplary method can be performed by a network management system (NMS, e.g., OAM system or similar) or a core network node or function (e.g., AMF).

In general, the exemplary method shown in FIG. 13 can be performed by a network node or function that includes, or is associated with, communication interface circuitry (e.g., radio or optical transceivers, network interface cards, etc.) configured to communicate with the RAN and with UEs served by the RAN. The communication interface circuitry can be operatively coupled to processing circuitry, e.g., processors and memories storing instructions executable by the processors. The processing circuitry and the communication interface circuitry are configured to cooperatively perform operations corresponding to the exemplary method shown in FIG. 13. However, the processing circuitry and the communication circuitry are not necessarily dedicated to this functionality and, in some cases, can be shared with similar or different functionality (e.g., in a cloud infrastructure arrangement).

The exemplary method can include the operations of block 1310, where the network node or function can send, to a RAN node, a second configuration of application-layer measurements to be performed by a UE served by the RAN node. The exemplary method can also include the operations of block 1320, where the network node or function can receive the following from the RAN node:
a first measurement report related to radio-layer measurements performed by the UE,
a second measurement report related to the application-layer measurements performed by the UE in relation to one or more applications,
a third measurement report related to radio-layer measurements performed by the RAN node, and
an indication that at least one of the first and third measurement reports is linked to the second measurement report.

In some embodiments, the radio-layer measurements by the UE can be MDT or trace measurements, while the application-layer measurements by the UE can be QoE measurements.

In various embodiments, the second configuration includes one or more of the following:
a pause criterion for UE application-layer measurements that is related to UE radio-layer measurements,
a second absolute time,
a time offset relative to a first absolute time included in the first configuration, and
an indication that UE application-layer measurement reports should include associations between radio resources and particular applications.

In some embodiments, the one or more applications include a plurality of applications and the second configuration includes a corresponding plurality of second configurations for the plurality of applications (i.e., one configuration per application).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

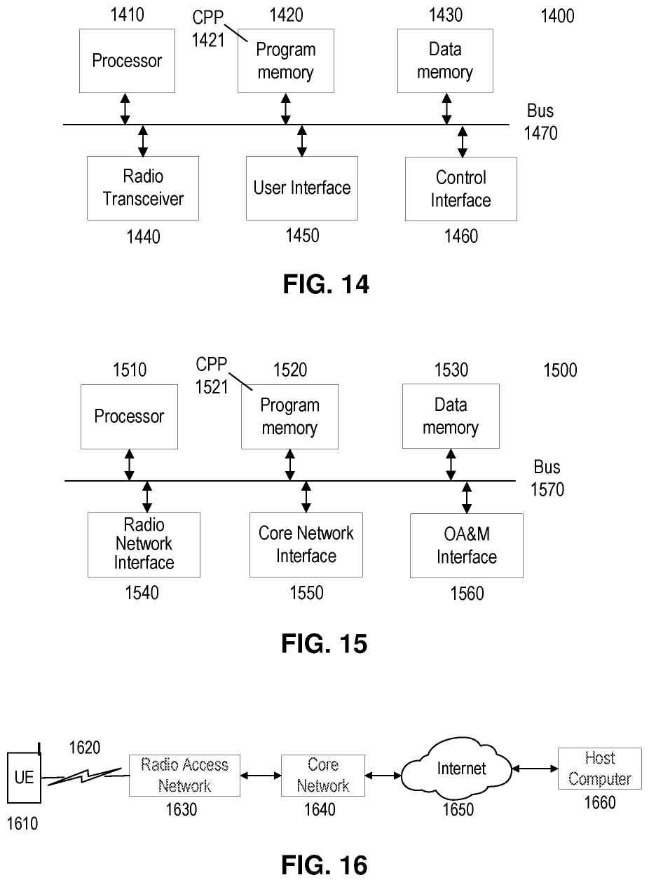

FIG. 14 shows a block diagram of an exemplary wireless device or user equipment (UE) 1400 (hereinafter referred to as “UE 1400”) according to various embodiments of the present disclosure, including those described above with reference to other figures. For example, UE 1400 can be configured by execution of instructions, stored on a computer-readable medium, to perform operations corresponding to one or more of the exemplary methods described herein.

UE 1400 can include a processor 1410 (also referred to as “processing circuitry”) that can be operably connected to a program memory 1420 and/or a data memory 1430 via a bus 1470 that can comprise parallel address and data buses, serial ports, or other methods and/or structures known to those of ordinary skill in the art. Program memory 1420 can store software code, programs, and/or instructions (collectively shown as computer program product (CPP) 1421 in FIG. 14) that, when executed by processor 1410, can configure and/or facilitate UE 1400 to perform various operations, including operations corresponding to various exemplary methods described herein. As part of or in addition to such operations, execution of such instructions can configure and/or facilitate UE 1400 to communicate using one or more wired or wireless communication protocols, including one or more wireless communication protocols standardized by 3GPP, 3GPP2, or IEEE, such as those commonly known as 5G/NR, LTE, LTE-A, UMTS, HSPA, GSM, GPRS, EDGE, 1xRTT, CDMA2000, 802.11 WiFi, HDMI, USB, Firewire, etc., or any other current or future protocols that can be utilized in conjunction with radio transceiver 1440, user interface 1450, and/or control interface 1460.

As another example, processor 1410 can execute program code stored in program memory 1420 that corresponds to MAC, RLC, PDCP, and RRC layer protocols standardized by 3GPP (e.g., for NR and/or LTE). As a further example, processor 1410 can execute program code stored in program memory 1420 that, together with radio transceiver 1440, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA). As another example, processor 1410 can execute program code stored in program memory 1420 that, together with radio transceiver 1440, implements device-to-device (D2D) communications with other compatible devices and/or UEs.

Program memory 1420 can also include software code executed by processor 1410 to control the functions of UE 1400, including configuring and controlling various components such as radio transceiver 1440, user interface 1450, and/or control interface 1460. Program memory 1420 can also comprise one or more application programs and/or modules comprising computer-executable instructions embodying any of the exemplary methods described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 1420 can comprise an external storage arrangement (not shown) remote from UE 1400, from which the instructions can be downloaded into program memory 1420 located within or removably coupled to UE 1400, so as to enable execution of such instructions.

Data memory 1430 can include memory area for processor 1410 to store variables used in protocols, configuration, control, and other functions of UE 1400, including operations corresponding to, or comprising, any of the exemplary methods described herein. Moreover, program memory 1420 and/or data memory 1430 can include non-volatile memory (e.g., flash memory), volatile memory (e.g., static or dynamic RAM), or a combination thereof. Furthermore, data memory 1430 can comprise a memory slot by which removable memory cards in one or more formats (e.g., SD Card, Memory Stick, Compact Flash, etc.) can be inserted and removed.

Persons of ordinary skill will recognize that processor 1410 can include multiple individual processors (including, e.g., multi-core processors), each of which implements a portion of the functionality described above. In such cases, multiple individual processors can be commonly connected to program memory 1420 and data memory 1430 or individually connected to multiple individual program memories and or data memories. More generally, persons of ordinary skill in the art will recognize that various protocols and other functions of UE 1400 can be implemented in many different computer arrangements comprising different combinations of hardware and software including, but not limited to, application processors, signal processors, general-purpose processors, multi-core processors, ASICs, fixed and/or programmable digital circuitry, analog baseband circuitry, radio-frequency circuitry, software, firmware, and middleware.

Radio transceiver 1440 can include radio-frequency transmitter and/or receiver functionality that facilitates the UE 1400 to communicate with other equipment supporting like wireless communication standards and/or protocols. In some exemplary embodiments, the radio transceiver 1440 includes one or more transmitters and one or more receivers that enable UE 1400 to communicate according to various protocols and/or methods proposed for standardization by 3GPP and/or other standards-setting organizations (SSOs). For example, such functionality can operate cooperatively with processor 1410 to implement a PHY layer based on OFDM, OFDMA, and/or SC-FDMA technologies, such as described herein with respect to other figures.

In some exemplary embodiments, radio transceiver 1440 includes one or more transmitters and one or more receivers that can facilitate the UE 1400 to communicate with various LTE, LTE-Advanced (LTE-A), and/or NR networks according to standards promulgated by 3GPP. In some exemplary embodiments of the present disclosure, the radio transceiver 1440 includes circuitry, firmware, etc. necessary for the UE 1400 to communicate with various NR, NR-U, LTE, LTE-A, LTE-LAA, UMTS, and/or GSM/EDGE networks, also according to 3GPP standards. In some embodiments, radio transceiver 1440 can include circuitry supporting D2D communications between UE 1400 and other compatible devices.

In some embodiments, radio transceiver 1440 includes circuitry, firmware, etc. necessary for the UE 1400 to communicate with various CDMA2000 networks, according to 3GPP2 standards. In some embodiments, the radio transceiver 1440 can be capable of communicating using radio technologies that operate in unlicensed frequency bands, such as IEEE 802.11 WiFi that operates using frequencies in the regions of 2.4, 5.6, and/or 60 GHz. In some embodiments, radio transceiver 1440 can include a transceiver that is capable of wired communication, such as by using IEEE 802.3 Ethernet technology. The functionality particular to each of these embodiments can be coupled with and/or controlled by other circuitry in the UE 1400, such as the processor 1410 executing program code stored in program memory 1420 in conjunction with, and/or supported by, data memory 1430.

User interface 1450 can take various forms depending on the particular embodiment of UE 1400, or can be absent from UE 1400 entirely. In some embodiments, user interface 1450 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the UE 1400 can comprise a tablet computing device including a larger touchscreen display. In such embodiments, one or more of the mechanical features of the user interface 1450 can be replaced by comparable or functionally equivalent virtual user interface features (e.g., virtual keypad, virtual buttons, etc.) implemented using the touchscreen display, as familiar to persons of ordinary skill in the art. In other embodiments, the UE 1400 can be a digital computing device, such as a laptop computer, desktop computer, workstation, etc. that comprises a mechanical keyboard that can be integrated, detached, or detachable depending on the particular embodiment. Such a digital computing device can also comprise a touch screen display. Many exemplary embodiments of the UE 1400 having a touch screen display are capable of receiving user inputs, such as inputs related to exemplary methods described herein or otherwise known to persons of ordinary skill.

In some embodiments, UE 1400 can include an orientation sensor, which can be used in various ways by features and functions of UE 1400. For example, the UE 1400 can use outputs of the orientation sensor to determine when a user has changed the physical orientation of the UE 1400's touch screen display. An indication signal from the orientation sensor can be available to any application program executing on the UE 1400, such that an application program can change the orientation of a screen display (e.g., from portrait to landscape) automatically when the indication signal indicates an approximate 90-degree change in physical orientation of the device. In this exemplary manner, the application program can maintain the screen display in a manner that is readable by the user, regardless of the physical orientation of the device. In addition, the output of the orientation sensor can be used in conjunction with various exemplary embodiments of the present disclosure.

A control interface 1460 of the UE 1400 can take various forms depending on the particular exemplary embodiment of UE 1400 and of the particular interface requirements of other devices that the UE 1400 is intended to communicate with and/or control. For example, the control interface 1460 can comprise an RS-232 interface, a USB interface, an HDMI interface, a Bluetooth interface, an IEEE (“Firewire”) interface, an I²C interface, a PCMCIA interface, or the like. In some exemplary embodiments of the present disclosure, control interface 1460 can comprise an IEEE 802.3 Ethernet interface such as described above. In some exemplary embodiments of the present disclosure, the control interface 1460 can comprise analog interface circuitry including, for example, one or more digital-to-analog converters (DACs) and/or analog-to-digital converters (ADCs).

Persons of ordinary skill in the art can recognize the above list of features, interfaces, and radio-frequency communication standards is merely exemplary, and not limiting to the scope of the present disclosure. In other words, the UE 1400 can comprise more functionality than is shown in FIG. 14 including, for example, a video and/or still-image camera, microphone, media player and/or recorder, etc. Moreover, radio transceiver 1440 can include circuitry necessary to communicate using additional radio-frequency communication standards including Bluetooth, GPS, and/or others. Moreover, the processor 1410 can execute software code stored in the program memory 1420 to control such additional functionality. For example, directional velocity and/or position estimates output from a GPS receiver can be available to any application program executing on the UE 1400, including any program code corresponding to and/or embodying any exemplary embodiments (e.g., of methods) described herein.

FIG. 15 shows a block diagram of an exemplary network node 1500 according to various embodiments of the present disclosure, including those described above with reference to other figures. For example, exemplary network node 1500 can be configured by execution of instructions, stored on a computer-readable medium, to perform operations corresponding to one or more of the exemplary methods described herein. In some exemplary embodiments, network node 1500 can comprise a base station, eNB, gNB, or one or more components thereof. For example, network node 1500 can be configured as a central unit (CU) and one or more distributed units (DUs) according to NR gNB architectures specified by 3GPP. More generally, the functionally of network node 1500 can be distributed across various physical devices and/or functional units, modules, etc.

Network node 1500 can include processor 1510 (also referred to as “processing circuitry”) that is operably connected to program memory 1520 and data memory 1530 via bus 1570, which can include parallel address and data buses, serial ports, or other methods and/or structures known to those of ordinary skill in the art.

Program memory 1520 can store software code, programs, and/or instructions (collectively shown as computer program product (CPP) 1521 in FIG. 15) that, when executed by processor 1510, can configure and/or facilitate network node 1500 to perform various operations, including operations corresponding to various exemplary methods described herein. As part of and/or in addition to such operations, program memory 1520 can also include software code executed by processor 1510 that can configure and/or facilitate network node 1500 to communicate with one or more other UEs or network nodes using other protocols or protocol layers, such as one or more of the PHY, MAC, RLC, PDCP, and RRC layer protocols standardized by 3GPP for LTE, LTE-A, and/or NR, or any other higher-layer (e.g., NAS) protocols utilized in conjunction with radio network interface 1540 and/or core network interface 1550. By way of example, core network interface 1550 can comprise the S1 or NG interface and radio network interface 1540 can comprise the Uu interface, as standardized by 3GPP. Program memory 1520 can also comprise software code executed by processor 1510 to control the functions of network node 1500, including configuring and controlling various components such as radio network interface 1540 and core network interface 1550.

Data memory 1530 can comprise memory area for processor 1510 to store variables used in protocols, configuration, control, and other functions of network node 1500. As such, program memory 1520 and data memory 1530 can comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 1510 can include multiple individual processors (not shown), each of which implements a portion of the functionality described above. In such case, multiple individual processors may be commonly connected to program memory 1520 and data memory 1530 or individually connected to multiple individual program memories and/or data memories. More generally, persons of ordinary skill will recognize that various protocols and other functions of network node 1500 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 1540 can comprise transmitters, receivers, signal processors, ASICs, antennas, beamforming units, and other circuitry that enables network node 1500 to communicate with other equipment such as, in some embodiments, a plurality of compatible user equipment (UE). In some embodiments, interface 1540 can also enable network node 1500 to communicate with compatible satellites of a satellite communication network. In some exemplary embodiments, radio network interface 1540 can comprise various protocols or protocol layers, such as the PHY, MAC, RLC, PDCP, and/or RRC layer protocols standardized by 3GPP for LTE, LTE-A, LTE-LAA, NR, NR-U, etc.; improvements thereto such as described herein above; or any other higher-layer protocols utilized in conjunction with radio network interface 1540. According to further exemplary embodiments of the present disclosure, the radio network interface 1540 can comprise a PHY layer based on OFDM, OFDMA, and/or SC-FDMA technologies. In some embodiments, the functionality of such a PHY layer can be provided cooperatively by radio network interface 1540 and processor 1510 (including program code in memory 1520).

Core network interface 1550 can comprise transmitters, receivers, and other circuitry that enables network node 1500 to communicate with other equipment in a core network such as, in some embodiments, circuit-switched (CS) and/or packet-switched Core (PS) networks. In some embodiments, core network interface 1550 can comprise the S1 interface standardized by 3GPP. In some embodiments, core network interface 1550 can comprise the NG interface standardized by 3GPP. In some exemplary embodiments, core network interface 1550 can comprise one or more interfaces to one or more AMFs, SMFs, SGWs, MMEs, SGSNs, GGSNs, and other physical devices that comprise functionality found in GERAN, UTRAN, EPC, SGC, and CDMA2000 core networks that are known to persons of ordinary skill in the art. In some embodiments, these one or more interfaces may be multiplexed together on a single physical interface. In some embodiments, lower layers of core network interface 1550 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

In some embodiments, network node 1500 can include hardware and/or software that configures and/or facilitates network node 1500 to communicate with other network nodes in a RAN (also referred to as a “wireless network”), such as with other eNBs, gNBs, ng-eNBs, en-gNBs, IAB nodes, etc. Such hardware and/or software can be part of radio network interface 1540 and/or core network interface 1550, or it can be a separate functional unit (not shown). For example, such hardware and/or software can configure and/or facilitate network node 1500 to communicate with other RAN nodes via the X2 or Xn interfaces, as standardized by 3GPP.

OA&M interface 1560 can comprise transmitters, receivers, and other circuitry that enables network node 1500 to communicate with external networks, computers, databases, and the like for purposes of operations, administration, and maintenance of network node 1500 or other network equipment operably connected thereto. Lower layers of OA&M interface 1560 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 1540, core network interface 1550, and OA&M interface 1560 may be multiplexed together on a single physical interface, such as the examples listed above.

FIG. 16 is a block diagram of an exemplary communication network configured to provide over-the-top (OTT) data services between a host computer and a user equipment (UE), according to various exemplary embodiments of the present disclosure. UE 1610 can communicate with radio access network (RAN, also referred to as “wireless network”) 1630 over radio interface 1620, which can be based on protocols described above including, e.g., LTE, LTE-A, and 5G/NR. For example, UE 1610 can be configured and/or arranged as shown in other figures discussed above.

RAN 1630 can include one or more terrestrial network nodes (e.g., base stations, eNBs, gNBs, controllers, etc.) operable in licensed spectrum bands, as well one or more network nodes operable in unlicensed spectrum (using, e.g., LAA or NR-U technology), such as a 2.4-GHz band and/or a 5-GHz band. In such cases, the network nodes comprising RAN 1630 can cooperatively operate using licensed and unlicensed spectrum. In some embodiments, RAN 1630 can include, or be capable of communication with, one or more satellites comprising a satellite access network.

RAN 1630 can further communicate with core network 1640 according to various protocols and interfaces described above. For example, one or more apparatus (e.g., base stations, eNBs, gNBs, etc.) comprising RAN 1630 can communicate to core network 1640 via core network interface 1650 described above. In some exemplary embodiments, RAN 1630 and core network 1640 can be configured and/or arranged as shown in other figures discussed above. For example, eNBs comprising an E-UTRAN 1630 can communicate with an EPC core network 1640 via an S1 interface. As another example, gNBs and ng-eNBs comprising an NG-RAN 1630 can communicate with a 5GC core network 1630 via an NG interface.

Core network 1640 can further communicate with an external packet data network, illustrated in FIG. 16 as Internet 1650, according to various protocols and interfaces known to persons of ordinary skill in the art. Many other devices and/or networks can also connect to and communicate via Internet 1650, such as exemplary host computer 1660. In some exemplary embodiments, host computer 1660 can communicate with UE 1610 using Internet 1650, core network 1640, and RAN 1630 as intermediaries. Host computer 1660 can be a server (e.g., an application server) under ownership and/or control of a service provider. Host computer 1660 can be operated by the OTT service provider or by another entity on the service provider's behalf.

For example, host computer 1660 can provide an over-the-top (OTT) packet data service to UE 1610 using facilities of core network 1640 and RAN 1630, which can be unaware of the routing of an outgoing/incoming communication to/from host computer 1660. Similarly, host computer 1660 can be unaware of routing of a transmission from the host computer to the UE, e.g., the routing of the transmission through RAN 1630. Various OTT services can be provided using the exemplary configuration shown in FIG. 16 including, e.g., streaming (unidirectional) audio and/or video from host computer to UE, interactive (bidirectional) audio and/or video between host computer and UE, interactive messaging or social communication, interactive virtual or augmented reality, etc.

The exemplary network shown in FIG. 16 can also include measurement procedures and/or sensors that monitor network performance metrics including data rate, latency and other factors that are improved by exemplary embodiments disclosed herein. The exemplary network can also include functionality for reconfiguring the link between the endpoints (e.g., host computer and UE) in response to variations in the measurement results. Such procedures and functionalities are known and practiced; if the network hides or abstracts the radio interface from the OTT service provider, measurements can be facilitated by proprietary signaling between the UE and the host computer.

The embodiments described herein provide novel techniques for configuring, performing, and reporting linked and/or associated radio-layer (e.g., trace, MDT) and application-layer (e.g., QoE) measurements by UEs and RAN nodes. Such techniques can facilitate better analysis and optimization decisions in the RAN, while avoiding unnecessary network traffic carrying the same measurements in different measurement reports. When used in NR UEs (e.g., UE 1610) and gNBs (e.g., gNBs comprising RAN 1630), embodiments described herein can provide various improvements, benefits, and/or advantages that can improve QoE determination and network optimization for OTT applications and/or services. As a consequence, this improves the performance of these services as experienced by OTT service providers and end-users, including more precise delivery of services with lower latency without excessive UE energy consumption or other reductions in user experience. Also, improved OTT service performance increases the value of such services to end users and service providers.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Furthermore, functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that, although these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

As used herein unless expressly stated to the contrary, the phrases “at least one of” and “one or more of,” followed by a conjunctive list of enumerated items (e.g., “A and B”, “A, B, and C”), are intended to mean “at least one item, with each item selected from the list consisting of” the enumerated items. For example, “at least one of A and B” is intended to mean any of the following: A; B; A and B. Likewise, “one or more of A, B, and C” is intended to mean any of the following: A; B; C; A and B; B and C; A and C; A, B, and C.

As used herein unless expressly stated to the contrary, the phrase “a plurality of” followed by a conjunctive list of enumerated items (e.g., “A and B”, “A, B, and C”) is intended to mean “multiple items, with each item selected from the list consisting of” the enumerated items. For example, “a plurality of A and B” is intended to mean any of the following: more than one A; more than one B; or at least one A and at least one B.

Embodiments of the techniques and apparatus described herein also include, but are not limited to, the following enumerated examples:

A1. A method for a user equipment (UE) to perform linked radio-layer and application-layer measurements in a radio access network (RAN), the method comprising:
receiving the following from a RAN node:
   a first configuration of radio-layer measurements to be performed by the UE,
   a second configuration of application-layer measurements to be performed by the UE, and an indication that the radio-layer and application-layer measurements should be
   linked;
based on the second configuration, performing application-layer measurements related to one or more applications; and
performing radio-layer measurements based on the first configuration, wherein at least a portion of the radio-layer measurements are performed concurrently with at least a portion of the application-layer measurements.
   A2. The method of embodiment A1, wherein performing the application-layer measurements comprises:
receiving, by a UE application layer from a UE radio layer, one of the following first control indications for the application-layer measurements:
   a start indication,
   a stop indication,
   a suspend indication, and
   a resume indication; and
performing one of the following operations in response to the received first control indication:
   initiating the application-layer measurements in response to the start indication;
   stopping ongoing application-layer measurements in response to the stop indication;
   suspending ongoing application-layer measurements in response to the suspend indication; and
   resuming suspended application-layer measurements in response to the resume indication.
      A3. The method of embodiment A2, wherein:
the suspend indication includes a suspend duration; and
performing application-layer measurements comprises resuming suspended application-layer measurements after expiration of the received suspend duration.
   A4. The method of any of embodiments A2-A3, wherein:
the first control indication is received in association with an identification of at least one application, of the one or more applications, to which the first control indication applies; and
the responsive operation is performed only on the identified at least one application.
   A4a. The method of any of embodiments A2-A4, wherein the first control indication is received by the UE application layer in association with a data packet from the UE radio layer.
   A5. The method of any of embodiments A1-A4a, wherein performing radio-layer measurements comprises:
receiving, by a UE radio layer from a UE application layer, one of the following second control indications for the radio-layer measurements:
   a start indication,
   a stop indication,
   a suspend indication, and
   a resume indication; and
performing one of the following operations in response to the second control indication:
   initiating the radio-layer measurements in response to the start indication;
   stopping ongoing radio-layer measurements in response to the stop indication;
   suspend ongoing radio-layer measurements in response to the suspend indication; and
   resuming paused radio-layer measurements in response to the resume indication.
      A6. The method of embodiment A5, wherein:
the suspend indication includes a suspend duration; and
performing radio-layer measurements comprises resuming suspended radio-layer measurements after expiration of the received suspend duration.
   A6a. The method of any of embodiments A5-A6, wherein the second control indication is received by the UE radio layer in association with a data packet from the UE application layer.
   A7. The method of any of embodiments A1-A6a, wherein the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.
   A8. The method of any of embodiments A1-A7, wherein the first configuration includes one or more of the following:
a pause criterion for the radio-layer measurements that is related to the application-layer measurements,
an absolute time,
a time offset relative to an absolute time included in the second configuration,
an indication that radio-layer measurement reports should include associations between radio resources and particular applications, and
a request to inform the RAN node when the UE radio layer receives a first control indication from the UE application layer.
   A8a. The method of any of embodiments A1-A8, wherein the second configuration includes one or more of the following:
a pause criterion for the application-layer measurements that is related to the radio-layer measurements,
an absolute time,
a time offset relative to an absolute time included in the first configuration, and
an indication that application-layer measurement reports should include associations between radio resources and particular applications.
   A9. The method of any of embodiments A1-A8a, wherein:
the radio-layer measurements are performed based on the first configuration while the UE is operating in a first cell;
the method further comprises connecting to a second cell and performing radio-layer measurements in the second cell based on a further first configuration; and
the application-layer measurements are performed in the first and second cells based on the second configuration.
   A10. The method of any of embodiments A1-A9, further comprising sending, to the RAN node, one or more of the following:
one or more measurement timing parameters included in the second configuration,
a first measurement report related to the performed radio-layer measurements,
a second measurement report related to the performed application-layer measurements,
an indication that the UE initiated the application-layer measurements,
a request to perform radio-layer measurements at the RAN node, and
an absolute or relative time at which the RAN node should perform radio-layer measurements.
   A11. The method of any of embodiments A1-A10, wherein:
the one or more applications include a plurality of applications; and
the second configuration includes a corresponding plurality of second configurations for the plurality of applications.
   A12. The method of embodiment A11, wherein:
the first configuration of radio-layer measurements is associated with the plurality of applications; and
the first configuration is related to the respective second configurations based on one or more of the following:
   a first sampling rate that is a common multiple of respective second sampling rates, and
   each first sampling occasion is concurrent with a second sampling occasion associated with one of the plurality of second configurations.
      A13. The method of embodiment A11, wherein the first configuration includes a corresponding plurality of first configurations associated with the respective plurality of second configurations.
      A14. The method of any of embodiments A1-A13, wherein:
the radio-layer measurements are minimization of drive testing (MDT) or trace measurements, and
the application-layer measurements are quality-of-experience (QoE) measurements.
   B1. A method, for a node in a radio access network (RAN), to configure a user equipment (UE) to perform linked radio-layer and application-layer measurements, the method comprising:
receiving, from a network node or function outside the RAN, a second configuration of application-layer measurements to be performed by the UE in relation to one or more applications;
sending the following to the UE:
   a first configuration of radio-layer measurements to be performed by the UE,
   the second configuration, and
   an indication that the radio-layer and application-layer measurements by the UE should be linked;
performing radio-layer measurements that are linked with application-layer measurements performed by the UE based on the second configuration.
   B2. The method of embodiment B1, wherein the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.
   B3. The method of any of embodiments B1-B2, wherein the first configuration includes one or more of the following:
a pause criterion for the UE radio-layer measurements that is related to the UE application-layer measurements,
an absolute time,
a time offset relative to an absolute time included in the second configuration,
an indication that UE radio-layer measurement reports should include associations between radio resources and particular applications, and
a request to inform the RAN node when the UE radio layer receives a first control indication from the UE application layer.
   B4. The method of any of embodiments B1-B3, wherein the second configuration includes one or more of the following:
a pause criterion for the UE application-layer measurements that is related to the UE radio-layer measurements,
an absolute time,
a time offset relative to an absolute time included in the first configuration, and
an indication that UE application-layer measurement reports should include associations between radio resources and particular applications.
   B5. The method of any of embodiments B1-B4, further comprising receiving, from the UE, one or more of the following:
one or more measurement timing parameters included in the second configuration,
a first measurement report related to UE radio-layer measurements,
a second measurement report related to UE application-layer measurements,
an indication that the UE initiated the application-layer measurements,
a request to perform radio-layer measurements at the RAN node, and
an absolute or relative time at which the RAN node should perform radio-layer measurements.
   B6. The method of embodiment B5, wherein performing the radio-layer measurements is responsive to one of the following:
the second measurement report,
the indication that the UE initiated the application-layer measurements, and
the request to perform radio-layer measurements at the RAN node.
   B6a. The method of any of embodiment B5-B6, further comprising sending the following to the network node or function outside the RAN:
the first measurement report from the UE,
the second measurement report from the UE,
a third measurement report related to the radio-layer measurements performed by the RAN node, and
an indication that the first, second, and third measurement reports are linked.
   B7. The method of any of embodiments B1-B4, wherein:
the method further comprises determining a starting time and/or a duration for the UE application-layer measurements based on one or more of the following:
   inspection of the second configuration received from the network node or function outside the RAN,
   one or more measurement timing parameters included in the second configuration, as received from the UE,
   inspection of application session initiation messages forwarded by the RAN node to or from the UE, and
   inspection of application session data packets forwarded by the RAN node to or from the UE; and
the radio-layer measurements are performed based on the determined starting time and/or duration for the UE application-layer measurements.
   B8. The method of any of embodiments B1-B7, wherein:
the one or more applications include a plurality of applications; and
the second configuration includes a corresponding plurality of second configurations for the plurality of applications.
   B9. The method of embodiment B8, wherein:
the first configuration is associated with the plurality of applications; and
the first configuration is related to the respective second configurations based on one or more of the following:
   a first sampling rate that is a common multiple of respective second sampling rates, and
   each first sampling occasion is concurrent with a second sampling occasion associated with one of the plurality of second configurations.
      B10. The method of embodiment B9, wherein the first configuration includes a corresponding plurality of first configurations associated with the respective plurality of second configurations.
      B11. The method of any of embodiments B1-B10, wherein:
the first configuration is for minimization of drive testing (MDT) or trace measurements, and
the second configuration is for quality-of-experience (QoE) measurements.
   B12. The method of any of embodiments B1-B11, wherein the network node or function outside the RAN is one of the following:
an access and mobility management function (AMF) in a core network (CN), or
a network management system (NMS).
   C1. A method for network node or function) coupled to a radio access network (RAN), the method comprising:
sending, to a RAN node, a second configuration of application-layer measurements to be performed by a user equipment (UE) being served by the RAN node; and
receiving the following from the RAN node:
   a first measurement report related to radio-layer measurements performed by the UE,
   a second measurement report related to the application-layer measurements by the UE in relation to one or more applications,
   a third measurement report related to radio-layer measurements performed by the RAN node, and
   an indication that the first and third measurement reports are linked to the second measurement report.
      C2. The method of embodiment C1, wherein the second configuration includes one or more of the following:
a pause criterion for the UE application-layer measurements that is related to the UE radio-layer measurements,
an absolute time,
a time offset relative to an absolute time included in the first configuration, and
an indication that UE application-layer measurement reports should include associations between radio resources and particular applications.
   C3. The method of any of embodiments C1-C2, wherein:
the one or more applications include a plurality of applications; and
the second configuration includes a respective plurality of second configurations for the plurality of applications.
   C4. The method of any of embodiments C1-C3, wherein:
the radio-layer measurements by the UE are minimization of drive testing (MDT) or trace measurements, and
the application-layer measurements by the UE are quality-of-experience (QoE) measurements.
   C5. The method of any of embodiments C1-C4, wherein the network node or function is one of the following:
an access and mobility management function (AMF) in a core network (CN), or
a network management system (NMS).
   D1. A user equipment (UE) configured to perform linked radio-layer and application-layer measurements in a radio access network (RAN), the UE comprising:
radio transceiver circuitry configured to communicate with at least one RAN node; and
processing circuitry operatively coupled to the radio transceiver circuitry, whereby the processing circuitry and the radio transceiver circuitry are configured to perform operations corresponding to the methods of any of embodiments A1-A14.
   D2. A user equipment (UE) configured to perform linked radio-layer and application-layer measurements in a radio access network (RAN), the UE being further arranged to perform operations corresponding to the methods of any of embodiments A1-A14.
   D3. A non-transitory, computer-readable medium storing computer-executable instructions that, when executed by processing circuitry of a user equipment (UE) configured to perform linked radio-layer and application-layer measurements in a radio access network (RAN), configure the UE to perform operations corresponding to the methods of any of embodiments A1-A14.
   D4. A computer program product comprising computer-executable instructions that, when executed by processing circuitry of a user equipment (UE) configured to perform linked radio-layer and application-layer measurements in a radio access network (RAN), configure the UE to perform operations corresponding to the methods of any of embodiments A1-A14.
   E1. A radio access network (RAN) node arranged to configure user equipment (UEs) to perform linked radio-layer and application-layer measurements, the RAN node comprising:
communication interface circuitry configured to communicate with UEs and with a network management system (NMS); and
processing circuitry operatively coupled to the communication interface circuitry, whereby the processing circuitry and the communication interface circuitry are configured to perform operations corresponding to the methods of any of embodiments B1-B12.
   E2. A radio access network (RAN) node arranged to configure user equipment (UEs) to perform linked radio-layer and application-layer measurements, the RAN node being further arranged to perform operations corresponding to the methods of any of embodiments B1-B12.
   E3. A non-transitory, computer-readable medium storing computer-executable instructions that, when executed by processing circuitry of a radio access network (RAN) node arranged to configure user equipment (UEs) to perform linked radio-layer and application-layer measurements, configure the RAN node to perform operations corresponding to the methods of any of embodiments B1-B12.
   E4. A computer program product comprising computer-executable instructions that, when executed by processing circuitry of a radio access network (RAN) node arranged to configure user equipment (UEs) to perform linked radio-layer and application-layer measurements, configure the RAN node to perform operations corresponding to the methods of any of embodiments B1-B12.
   F1. A network node or function, coupled to a radio access network (RAN) and arranged to configure linked radio-layer and application-layer measurements in the RAN, the network node or function comprising:
communication interface circuitry configured to communicate with the RAN and with UEs served by the RAN; and
processing circuitry operatively coupled to the communication interface circuitry, whereby the processing circuitry and the communication interface circuitry are configured to perform operations corresponding to the methods of any of embodiments C1-C5.
   F2. A network node or function, coupled to a radio access network (RAN) and arranged to configure linked radio-layer and application-layer measurements in the RAN, the network node or function being further arranged to perform operations corresponding to the methods of any of embodiments C1-C5.
   F3. A non-transitory, computer-readable medium storing computer-executable instructions that, when executed by processing circuitry of a network node or function coupled to a radio access network (RAN) and arranged to configure linked radio-layer and application-layer measurements in the RAN, configure the network node or function to perform operations corresponding to the methods of any of embodiments C1-C5.
   F4. A computer program product comprising computer-executable instructions that, when executed by processing circuitry of a network node or function coupled to a radio access network (RAN) and arranged to configure linked radio-layer and application-layer measurements in the RAN, configure the network node or function to perform operations corresponding to the methods of any of embodiments C1-C5.

1.-44. (canceled)

45. A method for a user equipment (UE) to perform radio-layer and application-layer measurements in a radio access network (RAN), the method comprising:
receiving the following from a RAN node:
a first configuration of radio-layer measurements to be performed by the UE,
a second configuration of application-layer measurements to be performed by the UE, and
an indication that the radio-layer measurements and the application-layer measurements should be linked;
based on the second configuration, performing application-layer measurements related to one or more applications; and
performing radio-layer measurements based on the first configuration, wherein at least a portion of the radio-layer measurements are performed concurrently with at least a portion of the application-layer measurements,
wherein performing radio-layer measurements comprises receiving, by a UE radio layer from a UE application layer, a second start indication and initiating the radio-layer measurements in response to the second start indication.

46. The method of claim 45, wherein performing the application-layer measurements comprises:
receiving, by a UE application layer from a UE radio layer, one of the following first control indications for the application-layer measurements:
a first start indication,
a first stop indication,
a first suspend indication, or
a first resume indication; and
performing one of the following operations in response to the received first control indication:
initiating the application-layer measurements in response to the first start indication;
stopping ongoing application-layer measurements in response to the first stop indication;
suspending ongoing application-layer measurements in response to the first suspend indication; or
resuming suspended application-layer measurements in response to the first resume indication.

47. The method of claim 45, wherein performing radio-layer measurements further comprises:
receiving, by a UE radio layer from a UE application layer, one of the following second control indications for the radio-layer measurements:
a second stop indication,
a second suspend indication, or
a second resume indication; and
performing one of the following operations in response to the second control indication:
stopping ongoing radio-layer measurements in response to the second stop indication;
suspend ongoing radio-layer measurements in response to the second suspend indication; or
resuming paused radio-layer measurements in response to the second resume indication.

48. The method of claim 45, wherein the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.

49. The method of claim 45, wherein the first configuration includes one or more of the following:
a pause criterion for the radio-layer measurements that is related to the application-layer measurements,
a first absolute time,
a time offset relative to a second time included in the second configuration,
an indication that radio-layer measurement reports should include associations between radio resources and particular applications, and
a request to inform the RAN node when the UE radio layer receives a first control indication from the UE application layer.

50. The method of claim 45, wherein the second configuration includes one or more of the following:
a pause criterion for the application-layer measurements that is related to the radio-layer measurements,
a second absolute time,
a time offset relative to a first absolute time included in the first configuration, and
an indication that application-layer measurement reports should include associations between radio resources and particular applications.

51. The method of claim 45, wherein:
the radio-layer measurements are performed based on the first configuration while the UE is operating in a first cell;
the method further comprises connecting to a second cell and performing radio-layer measurements in the second cell based on a further first configuration; and
the application-layer measurements are performed in the first and second cells based on the second configuration.

52. The method of claim 45, further comprising sending, to the RAN node, one or more of the following:
one or more measurement timing parameters included in the second configuration,
a first measurement report related to the performed radio-layer measurements,
a second measurement report related to the performed application-layer measurements.

53. The method of claim 45, wherein:
the radio-layer measurements are minimization of drive testing (MDT) or trace measurements, and
the application-layer measurements are quality-of-experience (QoE) measurements.

54. A method for a radio access network (RAN) node to configure a user equipment (UE) to perform radio-layer and application-layer measurements, the method comprising:
receiving, from a network node or function outside the RAN, a second configuration of application-layer measurements to be performed by the UE in relation to one or more applications;
sending the following to the UE:
a first configuration of radio-layer measurements to be performed by the UE,
the second configuration, and
an indication that the radio-layer and application-layer measurements by the UE should be linked; and
performing radio-layer measurements that are linked with application-layer measurements performed by the UE based on the second configuration.

55. The method of claim 54, wherein the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.

56. The method of claim 54, wherein the first configuration includes one or more of the following:
a pause criterion for the UE radio-layer measurements that is related to the UE application-layer measurements,
a first absolute time,
a time offset relative to a second absolute time included in the second configuration,
an indication that UE radio-layer measurement reports should include associations between radio resources and particular applications, and
a request to inform the RAN node when the UE radio layer receives a first control indication from the UE application layer.

57. The method of claim 54, wherein the second configuration includes one or more of the following:
a pause criterion for the UE application-layer measurements that is related to the UE radio-layer measurements,
a second absolute time,
a time offset relative to a first absolute time included in the first configuration, and
an indication that UE application-layer measurement reports should include associations between radio resources and particular applications.

58. The method of claim 54, further comprising receiving, from the UE, one or more of the following:
one or more measurement timing parameters included in the second configuration,
a first measurement report related to UE radio-layer measurements, and
a second measurement report related to UE application-layer measurements.

59. The method of claim 54, wherein:
the first configuration is for minimization of drive testing (MDT) or trace measurements, and
the second configuration is for quality-of-experience (QoE) measurements.

60. A user equipment (UE) configured to perform radio-layer and application-layer measurements in a radio access network (RAN), the UE comprising:
radio transceiver circuitry configured to communicate with at least one RAN node; and
processing circuitry operatively coupled to the radio transceiver circuitry, whereby the processing circuitry and the radio transceiver circuitry are configured to:
receive the following from a RAN node:
a first configuration of radio-layer measurements to be performed by the UE,
a second configuration of application-layer measurements to be performed by the UE, and
an indication that the radio-layer and application-layer measurements should be linked;
based on the second configuration, perform application-layer measurements related to one or more applications; and
perform radio-layer measurements based on the first configuration, wherein at least a portion of the radio-layer measurements are performed concurrently with at least a portion of the application-layer measurements, wherein perform radio-layer measurements comprises to receive, by a UE radio layer from a UE application layer, a second start indication and initiating the radio-layer measurements in response to the second start indication.

61. The UE of claim 60, wherein the processing circuitry and the radio transceiver circuitry are configured to perform the application-layer measurements based on:
receiving, by a UE application layer from a UE radio layer, one of the following first control indications for the application-layer measurements:
a first start indication,
a first stop indication,
a first suspend indication, or
a first resume indication; and
performing one of the following operations in response to the received first control indication:
initiating the application-layer measurements in response to the first start indication;
stopping ongoing application-layer measurements in response to the first stop indication;
suspending ongoing application-layer measurements in response to the first suspend indication; or
resuming suspended application-layer measurements in response to the first resume indication.

62. The UE of claim 60, wherein the processing circuitry and the radio transceiver circuitry are configured to perform the application-layer measurements based on:
receiving, by a UE radio layer from a UE application layer, one of the following second control indications for the radio-layer measurements:
a second stop indication,
a second suspend indication, or
a second resume indication; and
performing one of the following operations in response to the second control indication:
stopping ongoing radio-layer measurements in response to the second stop indication;
suspend ongoing radio-layer measurements in response to the second suspend indication; or
resuming paused radio-layer measurements in response to the second resume indication.

63. A radio access network (RAN) node arranged to configure user equipment (UEs) to perform radio-layer and application-layer measurements, the RAN node comprising:
radio network interface circuitry configured to communicate with UEs and with a network management system (NMS); and
processing circuitry operatively coupled to the radio network interface circuitry, whereby the processing circuitry and the radio network interface circuitry are configured to perform operations corresponding to the method of claim 54.

64. The RAN node of claim 63, wherein the indication that the radio-layer and application-layer measurements should be linked comprises one or more of the following:
a radio-layer measurement identifier that is included in the second configuration,
an application-layer measurement identifier that is included in the first configuration,
a common sampling rate and duration included in the first and second configurations,
a common start time included in the first and second configurations,
a start time offset in one of the first and second configurations that is relative to a start time in the other of the first and second configurations,
a common end time included in the first and second configurations,
an end time offset in one of the first and second configurations that is relative to an end time in the other of the first and second configurations, and
an explicit indication that at least a portion of the radio-layer measurements should be performed concurrently with at least a portion of the application-layer measurements.
